(19) United States
(12) Patent Application Publication
(10) Pub. No.: US 2008/0300372 A1
(43) Pub. Date: Dec. 4, 2008

(54) Catalyst Activators, Processes for Making Same, and Use Thereof in Catalysts and Polymerization of Olefins

(76) Inventors: Lubin Luo, Baton Rouge, LA (US); Steven P. Diefenbach, Baton Rouge, LA (US); Zhike Wang, Baton Rouge, LA (US)

Correspondence Address: ALBEMARLE CORPORATION;PATENT DEPARTMENT, 451 FLORIDA STREET, BATON ROUGE, LA, 70801, US

(21) Appl. No.: 12/158,975

(22) PCT Filed: Dec. 20, 2006
(86) PCT No.: PCT/US06/62406

§ 371 Date: Jun. 23, 2008

Related U.S. Application Data
(60) Provisional application No. 60/752,992, filed on Dec. 21, 2005.
(60) Provisional application No. 60/753,061, filed on Dec. 21, 2005.
(60) Provisional application No. 60/752,993, filed on Dec. 21, 2005.
(60) Provisional application No. 60/753,037, filed on Dec. 21, 2005.

(51) Int. Cl. C08F 4/00; B01J 31/02

(52) U.S. Cl. 526/160; 502/152; 502/118; 502/63

(57) ABSTRACT

A composition useful for activating catalysts for olefin polymerization is provided. The composition is derived from at least: carrier; organoaluminoxy compound; component having at least one electron withdrawing group and at least one active proton; and Lewis base. Alternatively, the composition is derived from at least: carrier; organoaluminoxy compound; component having at least one electron withdrawing group and at least one active proton; and ionic compound having at least one active proton. Alternatively, the composition is derived from at least: carrier; organoaluminoxy compound; component having at least one electron donating group and at least one active proton; and, optionally, Lewis base. Alternatively, the composition is derived from at least: carrier; organoaluminoxy compound; component having at least one electron withdrawing group and at least one active proton; and component having at least one electron donating group and at least one active proton—and optionally, the composition comprises Lewis base.

### BACKGROUND

Partially hydrolyzed aluminum alkyl compounds known as aluminoxanes (AO) are used for activating transition metals for olefin polymerization activity. One such compound, methylaluminoxane (MAO), is a frequently chosen aluminum co-catalyst/activator in the industry. Considerable effort has been devoted to improving the effectiveness of catalyst systems based on use of aluminoxanes or modified aluminoxanes for polymerization of olefins. Representative patents and publications in the field of aluminoxane usage include the following: U.S. Pat. No. 5,324,800 to Welborn et al.; U.S. Pat. No. 4,752,597 to Turner; U.S. Pat. Nos. 4,960,878 and 5,041,584 to Crapo et al.; WO 96102580 to Dall'occo, et al.; EP 0 277 003 and EP 0 277 004 to Turner; Hlatky, Turner, and Eckman, J. Am. Chem. Soc., 1989, 111, 2728-2729; Hlatky and Upton, Macromolecules, 1996, 29, 8019-8020. U.S. Pat. No. 5,153,157 to Hlatky and Turner; U.S. Pat. No. 5,198,401 to Turner, Hlatky, and Eckman; Brintzinger, et al., Angew. Chem. Int. Ed. Engl., 1995, 34, 1143-1170; and the like. Despite technological advances, many aluminoxane-based polymerization catalyst activators still lack the activity and/or thermal stability needed for commercial applicability, require commercially unacceptably high aluminum loading, are expensive (especially MAO), and have other impediments to commercial implementation.

Many of the limiting features surrounding the use of aluminoxanes as activators for transition metals, for example, activity limitations—and the need for high aluminum loading, can be addressed by the use of stable or metastable hydroxyaluminoxanes. As compared to aluminoxanes, hydroxyaluminoxanes are generally highly active, provide reduced levels of ash, and result in improved clarity in polymers formed from such catalyst compositions. One representative hydroxyaluminoxane is hydroxyisobutylaluminoxane (HO-IBAO), which can be derived from the low-temperature hydrolysis of triisobutylaluminum (TIBA). Hydroxyaluminoxane compositions are disclosed in U.S. Pat. Nos. 6,662,991, 6,555,494, 6,492,292, 6,462,212, and 6,160,145.

In contrast to aluminoxanes, which appear to act as Lewis acids to activate transition metals, hydroxyaluminoxane species (generally abbreviated HO-AO) comprise active protons, and appear to activate transition metals by functioning as Bronsted acids. As used herein, an active proton is a proton capable of metal alkyl protonation. A typical hydroxyaluminoxane comprises a hydroxyl group bonded to at least one of its aluminum atoms. To form hydroxyaluminoxanes, typically a sufficient amount of water is reacted with an alkyl aluminum compound under appropriate conditions, for example at low temperature in hydrocarbon solvents, such that a compound having at least one HO—Al group is generated, which is capable of protonating a hydrocarbyl ligand from a d- or f-block organometallic compound to form a hydrocarbon. Therefore, polymerization catalysts derived from a hydroxyaluminoxane usually comprise: 1) a cation derived from a transition, lanthanide or actinide metal compound, for example a metallocene, by loss of a leaving group, and 2) an aluminoxate anion derived by transfer of a proton from a stable or metastable hydroxyaluminoxane to the leaving group. The leaving group is usually transformed into a neutral hydrocarbon thus rendering the catalyst-forming reaction irreversible.

One feature of hydroxyaluminoxanes is that their active protons are often thermally unstable when maintained in solution at ambient temperatures, likely due to the loss of active protons through alkane elimination. Thus, hydroxyaluminoxanes are frequently stored at temperatures lower than ambient temperature to maintain the active proton concentration. Typical low temperature storage is from about −20° C. to about 0° C. In the absence of such low temperature handling, the hydroxyaluminoxane activity decreases rapidly. Low-temperature storage is commercially cost prohibitive, especially over extended periods of time.

Thus, a need exists for hydroxyaluminoxane-type compositions that have more thermally-robust active protons, as compared to currently available hydroxyaluminoxanes, and that exhibit suitably high activity for commercial olefin polymerization.

### THE INVENTION

The present invention meets the above-described needs by providing compositions useful as activators with transition metal components in catalyzing the polymerization of olefins. Compositions according to this invention are adapted to activate alkylated transition metals by protonating the alkylated transition metal component (i.e., by Bronsted acid activation) and are particularly useful in polymerization of olefins.

### —Aspect One

Compositions according to this aspect of the invention are prepared by combining carrier, organoaluminoxy compound, component having at least one electron withdrawing group and at least one active proton, and Lewis base. In one embodiment, inorganic oxide is combined with organoaluminoxy compound and at least a portion of resulting product is combined with component having at least one electron withdrawing group and at least one active proton and Lewis base.

The following are provided by this invention: A composition derived from at least: a) carrier; b) organoaluminoxy compound; c) component having at least one electron withdrawing group and at least one active proton; and d) Lewis base; such a composition wherein the carrier comprises inorganic oxide; such a composition, wherein the inorganic oxide has a micro pore volume of not less than about 0.3 ml/g and an average particle diameter of about 10 micrometers to about 500 micrometers; such a composition wherein the inorganic oxide comprises silica, alumina, silica-alumina, magnesia, titania, zirconia, or clays; such a composition wherein the inorganic oxide comprises silica; such a composition wherein the organoaluminoxy compound comprises aluminoxane; such a composition wherein the aluminoxane comprises an alkylaluminoxane; such a composition wherein the alkylaluminoxane comprises methylaluminoxane, ethylaluminoxane, n-propylaluminoxane, iso-propylaluminoxane, n-butylaluminoxane, iso-butylaluminoxane, sec-butylaluminoxane, n-pentylaluminoxane, n-hexylaluminoxane, n-heptylaluminoxane, or n-octylaluminoxane; such a composition wherein the alkylaluminoxane comprises ethylaluminoxane; such a composition wherein the component having at least one electron withdrawing group and at least one active proton comprises pentafluorophenol, 2,3,5,6-tetrafluorophenol, 2,4,6-trifluorophenol, 2,3-difluorophenol, 2,4-difluorophenol, 2,5-difluorophenol, 2,6-difluorophenol, 3,4-difluorophenol, 3,5-difluorophenol, 2-fluorophenol, 3-fluorophenol, 4-fluorophenol, 2-trifluoromethylphenol, 3-trifluoromethylphenol, 4-trifluoromethylphenol, pentafluorobenzyl alcohol, pentafluorothiophenol, 2,2,2-trifluoroethyl alcohol, 1H,1H-pentafluoro-propanol, 1,1,1,3,3,3-hexafluoro-2-propyl alcohol, pentachlorophenol, pentabromophenol, 2-chloro-4-fluorophenol, 2-bromo-4-fluorophenol, 2-bromo-4,5-difluorophenol, tetrafluorocatechol, or tetrafluorohydroquinone; such a composition wherein the component having at least one electron withdrawing group and at least one active proton composes pentafluorophenol; such a composition wherein the Lewis base comprises at least one NR²₃, wherein each R² is independently hydrogen or a hydrocarbyl group having up to about 20 carbon atoms; such a composition, wherein the Lewis base comprises NMe₂Ph, NMe₂(CH₂Ph), NEt₂Ph, NEt₂(CH₂Ph), NMe(CₙH₂ₙ₊₁)(CₘH₂ₘ₊₁), NMe₂(CₙH₂ₙ₊₁), NEt(CₙH₂ₙ₊₁)(CₘH₂ₘ₊₁), or NEt₂(CₙH₂ₙ₊₁) and wherein n and m are independently an integer from 3 to 20; and such a composition, wherein the composition is adapted to activate an alkylated transition metal component by protonation. A catalyst for olefin polymerization, wherein the catalyst comprises a composition of this invention and alkylated transition metal component. A method of preparing a composition comprising combining at least: a) carrier; b) organoaluminoxy compound; c) component having at least one electron withdrawing group and at least one active proton; and d) Lewis base; such a method wherein the carrier comprises inorganic oxide; such a method wherein the carrier, the organoaluminoxy compound, the component having at least one electron withdrawing group and at least one active proton, and the Lewis base are combined in amounts sufficient and under conditions sufficient such that the composition is adapted to activate alkylated transition metal component by protonation; and such a method wherein the carrier is combined with the organoaluminoxy compound to form first product, at least a portion of the first product is combined with the component having at least one electron withdrawing group and at least one active proton to form second product, and at least a portion of the second product is combined with the Lewis base. A method of preparing a catalyst for olefin polymerization, comprising combining alkylated transition metal component with composition derived from at least carrier; organoaluminoxy compound; component having at least one electron withdrawing group and at least one active proton; and Lewis base. A method of polymerizing monomer comprising combining catalyst of this invention and monomer. A method of polymerizing monomer comprising combining composition of this invention, alkylated transition metal component, and monomer.

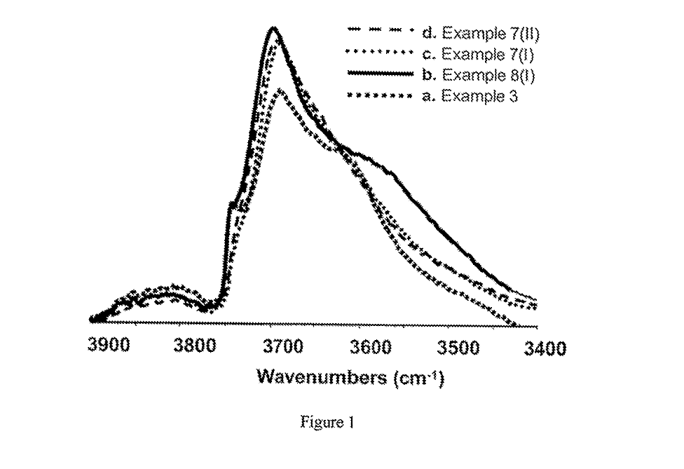

FIG. 1 shows O—H stretching frequencies in IR spectra of compositions according to this invention.

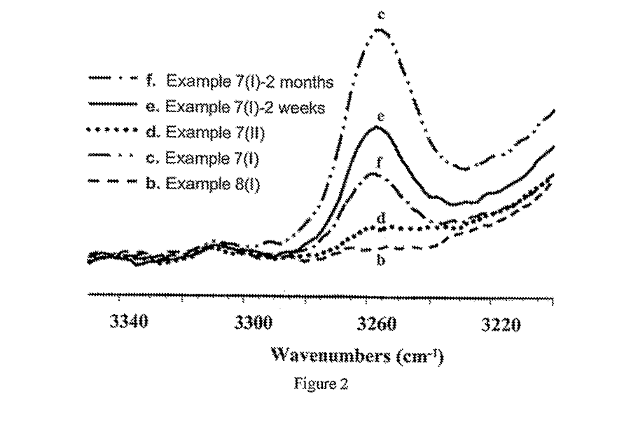

FIG. 2 shows N—H stretching frequencies in IR spectra of compositions according to this invention.

### —Aspect Two

Compositions according to this aspect of the invention are prepared by combining carrier, organoaluminoxy compound, component having at least one electron withdrawing group and at least one active proton, and ionic compound having at least one active proton. In one embodiment, the ionic compound is derived from at least Lewis base and component having at least one electron withdrawing group and at least one active proton. In one embodiment, inorganic oxide is combined with organoaluminoxy compound and at least a portion of resulting product is combined with component having at least one electron withdrawing group and at least one active proton and ionic compound having at least one active proton.

The following are provided by this invention: A composition derived from at least: a) carrier; b) organoaluminoxy compound; c) component having at least one electron withdrawing group and at least one active proton; and d) ionic compound having at least one active proton, such a composition, wherein the carrier comprises inorganic oxide; such a composition, wherein the inorganic oxide has a micro pore volume of not less than about 0.3 ml/g and an average particle diameter of about 10 micrometers to about 500 micrometers; such a composition wherein the inorganic oxide comprises silica, alumina, silica-alumina, magnesia, titania, zirconia, or clays; such a composition wherein the inorganic oxide comprises silica; such a composition wherein the organoaluminoxy compound comprises aluminoxane; such a composition wherein the aluminoxane comprises an alkylaluminoxane; such a composition wherein the alkylaluminoxane comprises methylaluminoxane, ethylaluminoxane, n-propylaluminoxane, iso-propylaluminoxane, n-butylaluminoxane, iso-butylaluminoxane, sec-butylaluminoxane, n-pentylaluminoxane, n-hexylaluminoxane, n-heptylaluminoxane, or n-octylaluminoxane; such a composition wherein the alkylaluminoxane comprises ethylaluminoxane; such a composition wherein the component having at least one electron withdrawing group and at least one active proton comprises pentafluorophenol, 2,3,5,6-tetrafluorophenol, 2,4,6-trifluorophenol, 2,3-difluorophenol, 2,4-difluorophenol, 2,5-difluorophenol, 2,6-difluorophenol, 3,4-difluorophenol, 3,5-difluorophenol, 2-fluorophenol, 3-fluorophenol, 4-fluorophenol, 2-trifluoromethylphenol, 3-trifluoromethylphenol, 4-trifluoromethylphenol, pentafluorobenzyl alcohol, pentafluorothiophenol, 2,2,2-trifluoroethyl alcohol, 1H,1H-pentafluoropropanol, 1,1,1,3,3,3-hexafluoro-2-propyl alcohol, pentachlorophenol, pentabromophenol, 2-chloro-4-fluorophenol, 2-bromo-4-fluorophenol, 2-bromo-4,5-difluorophenol, tetrafluorocatechol, or tetrafluorohydroquinone; such a composition wherein the component having at least one electron withdrawing group and at least one active proton comprises pentafluorophenol; such a composition, wherein the ionic compound having at least one active proton is derived from at least Lewis base and a portion of the component having at least one electron withdrawing group and at least one active proton; such a composition wherein the Lewis base comprises at least one NR²₃, wherein each R² is independently hydrogen or a hydrocarbyl group having up to about 20 carbon atoms; such a composition, wherein the Lewis base comprises NMe₂Ph, NMe₂(CH₂Ph), NEt₂Ph, NEt₂(CH₂Ph), NMe(CₙH₂ₙ₊₁)(CₘH₂ₘ₊₁), NMe₂(CₙH₂ₙ₊₁), NEt(CₙH₂ₙ₊₁)(CₘH₂ₘ₊₁), or NEt₂(CₙH₂ₙ₊₁) and wherein n and m are independently an integer from 3 to 20; and such a composition, wherein the composition is adapted to activate an alkylated transition metal component by protonation. A catalyst for olefin polymerization, wherein the catalyst comprises the composition of this invention and alkylated transition metal component. A method of preparing a composition comprising combining at least: a) carrier; b) organoaluminoxy compound; c) component having at least one electron withdrawing group and at least one active proton; and d) ionic compound having at least one active proton; such a method wherein the carrier comprises inorganic oxide; such a method wherein the carrier, the organoaluminoxy compound, the component having at least one electron withdrawing group and at least one active proton, and the ionic compound having at least one active proton are combined in amounts sufficient and under conditions sufficient such that the composition is adapted to activate alkylated transition metal component by protonation; and such a method wherein the carrier is combined with the organoaluminoxy compound to form first product, at least a portion of the first product is combined with the component having at least one electron withdrawing group and at least one active proton to form second product, and at least a portion of the second product is combined with the ionic compound having at least one active proton. A method of preparing a catalyst for olefin polymerization, comprising combining alkylated transition metal component with composition derived from at least carrier; organoaluminoxy compound, component having at least one electron withdrawing group and at least one active proton; and ionic compound having at least one active proton. A method of polymerizing monomer comprising combining catalyst of this invention and monomer. A method of polymerizing monomer comprising combining composition of this invention, alkylated transition metal component, and monomer.

### —Aspect Three

Compositions according to this aspect of the invention are prepared by combining carrier, organoaluminoxy compound, and component having at least one electron donating group and at least one active proton; optionally, Lewis base is included. In one embodiment inorganic oxide is combined with organoaluminoxy compound and at least a portion of resulting product is combined with component having at least one electron donating group and at least one active proton and, optionally, Lewis base.

The following are provided by this invention: A composition derived from at least: a) carrier; b) organoaluminoxy compound; and c) component having at least one electron donating group and at least one active proton; such a composition wherein the carrier comprises inorganic oxide; such a composition wherein the inorganic oxide comprises silica, alumina, silica-alumina, magnesia, titania, zirconia, or clays; such a composition wherein the inorganic oxide comprises silica, such a composition wherein the organoaluminoxy compound comprises alkylaluminoxane; such a composition wherein the alkylaluminoxane comprises methylaluminoxane, ethylaluminoxane, n-propylaluminoxane, iso-propylaluminoxane, n-butylaluminoxane, iso-butylaluminoxane, sec-butylaluminoxane, n-pentylaluminoxane, n-hexylaluminoxane, n-heptylaluminoxane, or n-octylaluminoxane; such a composition wherein the organoaluminoxy compound comprises ethylaluminoxane; such a composition wherein the component comprising at least one electron donating group and at least one active proton comprises phenolic alcohol, such a composition wherein the phenyl group of the phenolic alcohol is substituted with at least one group comprising alkyl, aryl, alkoxy, aryloxy, or fused aryl ring, any of which having up to about 10 carbon atoms, such a composition wherein the phenolic alcohol comprises 2,6-dimethylphenol, 2,6-isodipropylphenol, 2,6-t-dibutyl-4-methylphenol, 2-t-butyl-6-methylphenol, 2-phenoxyphenol, 2-t-butylphenol, or 2-isopropylphenol; and such a composition, wherein the phenyl group of the phenolic alcohol is substituted with at least one group characterized by a Hammett sigma (σ)-value that is negative. A composition derived from at least a) carrier; b) organoaluminoxy compound; c) component having at least one electron donating group and at least one active proton; and d) Lewis base; and such a composition, wherein the Lewis base has the formula NR¹₃, wherein each R¹ is independently hydrogen or a hydrocarbyl group having up to about 20 carbon atoms; such a composition, wherein the Lewis base is NMe₂Ph, NMe₂(CH₂Ph), NEt₂Ph, NEt₂(CH₂Ph), NMe(CₙH₂ₙ₊₁)(CₘH₂ₘ₊₁), NMe₂(CₙH₂ₙ₊₁), NEt(CₙH₂ₙ₊₁)(CₘH₂ₘ₊₁), NEt₂(CₙH₂ₙ₊₁), or any combination thereof, wherein n and m are independently an integer from 3 to 20. A method of preparing an activator composition comprising combining at least: a) carrier; b) organoaluminoxy compound; and c) component having at least one electron donating group and at least one active proton. A method of preparing an activator composition comprising combining at least: a) carrier; b) organoaluminoxy compound; c) component having at least one electron donating group and at least one active proton; and d) Lewis base. A method of preparing a catalyst for olefin polymerization, comprising combining alkylated transition metal component with composition derived from at least carrier, organoaluminoxy compound, and component having at least one electron donating group and at least one active proton; and such a method wherein the composition also comprises Lewis acid. A catalyst derived from at least: i) carrier; ii) organoaluminoxy compound; iii) component having at least one electron donating group and at least one active proton; and iv) transition metal component. A catalyst composition derived from at least: i) carrier; ii) organoaluminoxy compound; iii) component having at least one electron donating group and at least one active proton; iv) Lewis base; and v) transition metal component. A method of polymerizing monomer comprising combining catalyst of this invention and monomer. A method of polymerizing monomer comprising combining composition of this invention, alkylated transition metal component, and monomer.

### —Aspect Four

Compositions according to this aspect of the invention are prepared by combining carrier, organoaluminoxy compound, component having at least one electron withdrawing group and at least one active proton, and component having at least one electron donating group and at least one active proton; optionally, Lewis base is included in preparing the composition. In one embodiment, carrier, organoaluminoxy compound, component having at (east one electron withdrawing group and at least one active proton, and component having at least one electron donating group and at least one active proton are combined in any order. In one embodiment carrier, organoaluminoxy compound, component having at least one electron withdrawing group and at least one active proton, component having at least one electron donating group and at least one active proton, and Lewis base are combined in any order. In one embodiment, inorganic oxide is combined with organoaluminoxy compound and at least a portion of resulting product is combined with component having at least one electron withdrawing group and at least one active proton and with component having at least one electron donating group and at least one active proton.

The following are provided by this invention. A composition derived from at least: a) carrier; b) organoaluminoxy compound; c) component having at least one electron withdrawing group and at least one active proton; and d) component having at least one electron donating group and at least one active proton; such a composition, wherein the carrier comprises inorganic oxide; such a composition, wherein the inorganic oxide has a micro pore volume of not less than about 0.3 ml/g and an average particle diameter of about 10 micrometers to about 500 micrometers; such a composition of wherein the inorganic oxide comprises silica, alumina, silica-alumina, magnesia, titania, zirconia, or days; such a composition wherein the inorganic oxide comprises silica, such a composition wherein the organoaluminoxy compound comprises aluminoxane; such a composition wherein the aluminoxane comprises an alkylaluminoxane; such a composition wherein the alkylaluminoxane comprises methylaluminoxane, ethylaluminoxane, n-propylaluminoxane, iso-propylaluminoxane, n-butylaluminoxane, iso-butylaluminoxane, sec-butylaluminoxane, n-pentylaluminoxane, n-hexylaluminoxane, n-heptylaluminoxane, or n-octylaluminoxane; such a composition of this invention wherein the alkylaluminoxane comprises ethylaluminoxane; such a composition wherein the component having at least one electron withdrawing group and at least one active proton comprises pentafluorophenol, 2,3,5,6-tetrafluorophenol, 2,4,6-trifluorophenol, 2,3-difluorophenol, 2,4-difluorophenol, 2,5-difluorophenol, 2,6-difluorophenol, 3,4-difluorophenol, 3,5-difluorophenol, 2-fluorophenol, 3-fluorophenol, 4-fluorophenol, 2-trifluoromethylphenol, 3-trifluoromethylphenol, 4-trifluoromethylphenol, pentafluorobenzyl alcohol, pentafluorothiophenol, 2,2,2-trifluoroethyl alcohol, 1H,1H-pentafluoro-propanol, 1,1,1,3,3,3-hexafluoro-2-propyl alcohol, pentachlorophenol, pentabromophenol, 2-chloro-4-fluorophenol, 2-bromo-4-fluorophenol, 2-bromo-4,5-difluorophenol, tetrafluorocatechol, or tetrafluorohydroquinone; such a composition wherein the component having at least one electron withdrawing group and at least one active proton comprises pentafluorophenol, such a composition wherein the component having at least one electron donating group and at least one active proton comprises 2,6-dimethylphenol, 2,6-isodipropylphenol, 2,6-t-dibutyl-4-methylphenol, 2-t-butyl-6-methylphenol, 2-phenoxyphenol, 2-t-butylphenol, or 2-isopropylphenol; and such a composition wherein the component having at least one electron donating group and at least one active proton comprises 2,6-dimethylphenol. A composition derived from at least: a) carrier; b) organoaluminoxy compound; a) component having at least one electron withdrawing group and at least one active proton; d) component having at least one electron donating group and at least one active proton; and e) Lewis base; such a composition wherein the Lewis base comprises at least one NR²₃, wherein each R² is independently hydrogen or a hydrocarbyl group having up to about 20 carbon atoms; such a composition, wherein the Lewis base comprises NMe₂Ph, NMe₂(CH₂Ph), NEt₂Ph, NEt₂(CH₂Ph), NMe(CₙH₂ₙ₊₁)(CₘH₂ₘ₊₁), NMe₂(CₙH₂ₙ₊₁), NEt(CₙH₂ₙ₊₁)(CₘH₂ₘ₊₁) or NEt₂(CₙH₂ₙ₊₁) and wherein n and m are independently an integer from 3 to 20; such a composition, wherein the composition is adapted to activate an alkylated transition metal component by protonation. A catalyst for olefin polymerization, wherein the catalyst comprises the composition of this invention and alkylated transition metal component. A method of preparing a composition comprising combining in any order at least: a) carrier; b) organoaluminoxy compound; c) component having at least one electron withdrawing group and at least one active proton; and d) component having at least one electron donating group and at least one active proton; such a method wherein the carrier comprises inorganic oxide; and such a method wherein the carrier, the organoaluminoxy compound, the component having at least one electron withdrawing group and at least one active proton, and the component having at least one electron donating group and at least one active proton are combined in amounts sufficient and under conditions sufficient such that the composition is adapted to activate alkylated transition meta component by protonation; such a method wherein the carrier is combined with the organoaluminoxy compound to form first product, at least a portion of the first product is combined with the component having at least one electron withdrawing group and at least one active proton to form second product, and at least a portion of the second product is combined with the component having at least one electron donating group and at least one active proton. A method of preparing a composition comprising combining in any order at least: a) carrier; b) organoaluminoxy compound; c) component having at least one electron withdrawing group and at least one active proton; d) component having at least one electron donating group and at least one active proton; and e) Lewis base. A method of preparing a catalyst for olefin polymerization) comprising combining alkylated transition metal component with composition derived from at least carrier, organoaluminoxy compound; component having at least one electron withdrawing group and at least one active proton; and component having at least one electron donating group and at least one active proton. A method of preparing a catalyst for olefin polymerization, comprising combining alkylated transition metal component with composition derived from at least carrier; organoaluminoxy compound, component having at least one electron withdrawing group and at least one active proton; component having at least one electron donating group and at least one active proton; and Lewis base. A method of polymerizing monomer comprising combining catalyst of this invention and monomer. A method of polymerizing monomer comprising combining composition of this invention, alkylated transition metal component, and monomer.

### DETAILED DESCRIPTION

In this invention, the carrier (or support) for the composition can comprise organic carrier or inorganic carrier, for example, inorganic oxide. Organoaluminoxy compound can comprise alkylaluminoxy or modified aluminoxane. Activated transition metal components are formed as hereinafter described.

### (A) Carrier/Support

Carrier (A) comprises inorganic carrier or organic carrier. A plurality of carriers can be used as a mixture, and carrier (A) may comprise water, e.g., as absorbed water or in hydrate form. In certain embodiments, carrier (A) is porous and has a micro pore volume of not less than 0.1 ml/g of silica, or not less than 0.3 ml/g. In one embodiment, carrier (A) has a micro pore volume of about 1.6 ml/g of silica. In certain embodiments, the average particle diameter of carrier (A) is from about 5 micrometers to about 1000 micrometers, or from about 10 micrometers to about 500 micrometers.

In one embodiment, a silica useful in this invention is porous and has a surface area in the range of from about 10 m²/g silica to about 700 m²/g silica, a total pore volume in the range of from about 0.1 cc/g silica to about 4.0 cc/g silica, and an average particle diameter in the range of from about 10 micrometers to about 500 micrometers. In another embodiment, the silica has a surface area in the range of from about 50 m²/g to about 500 m²/g, a pore volume in the range of from about 0.5 cc/g to about 3.5 cc/g, and an average particle diameter in the range of from about 15 micrometers to about 150 micrometers. In still another embodiment, the silica has a surface area in the range of from about 200 m²/g to about 350 m²/g, a pore volume in the range of from about 1.0 cc/g to about 2.0 cc/g, and an average particle diameter in the range of from about 10 micrometers to about 110 micrometers.

In another embodiment, an average pore diameter of a typical porous silicon dioxide carrier (A) is in the range of from about 10 angstroms to about 1000 angstroms, and in yet another embodiment, from about 50 angstroms to about 500 angstroms, or from about 175 angstroms to about 350 angstroms. In this embodiment, the typical content of hydroxyl groups is from about 0.04 mmol OH/g silica to about 3.0 mmol OH/g silica) with or without the presence of free hydroxyl groups, as determined by the following Grignard reaction. Most of these active OH groups react readily with benzylmagnesium chloride Grignard to produce toluene, and this reaction can be used to quantify the concentration of active OH groups on a particular silica. In another embodiment, the typical content of hydroxyl groups is from about 0.10 mmol OH/g silica to about 2.0 mmol OH/g silica, or from about 0.4 mmol OH/g silica to about 1.5 mmol OH/g silica.

Example inorganic carriers that may be useful in this invention include inorganic oxides, magnesium compounds, clay minerals and the like. Example inorganic oxides useful in this invention include, without limitation, SiO₂, Al₂O₃, MgO, ZrO₂, TiO₂, B₂O₃, CaO, ZnO, BaO, ThO₂ and double oxides thereof e.g. SiO₂—Al₂O₃, SiO₂—MgO, SiO₂-iO₂, SiO₂—TiO₂—MgO. Example magnesium compounds useful in this invention include MgCl₂, MgCl(OEt) and the like. Example clay minerals useful in this invention include kaolin, bentonite, kibushi clay, geyloam clay, allophane, hisingerite pyrophylite, talc, micas, montmorillonites, vermiculite, chlorites, palygorskite, kaolinite, nacrite, dickite, halloysite and the like.

Example organic carriers that may be useful in this invention include acrylic polymer, styrene polymer, ethylene polymer, propylene polymer and the like. Example acrylic polymers that may be useful in this invention include polymers of acrylic monomers such as acrylonitrile, methyl acrylate, methyl methacrylate, methacrylonitrile and the like, and copolymers of the monomers and crosslinking polymerizable compounds having at least two unsaturated bonds. Example styrene polymers that may be useful in this invention include polymers of styrene monomers such as styrene, vinyltoluene, ethylvinylbenzene and the like, and copolymers of the monomers and crosslinking polymerizable compounds having at least two unsaturated bonds. Example crosslinking polymerizable compound having at least two unsaturated bonds include divinylbenzene, trivinylbenzene, divinyltoluene, divinylketone, diallyl phthalate, diallyl maleate, N,N′-methylenebisacrylamide, ethylene glycol dimethacrylate, polyethylene glycol dimethacrylate and the like.

In certain embodiments of this invention, organic carrier has at least one polar functional group. Examples of suitable polar functional groups include primary amino group, secondary amino group, imino group, amide group, imide group, hydrazide group, amidino group, hydroxy group, hydroperoxy-group, carboxyl group, formyl group, methyloxycarbonyl group, carbamoyl group, sulfo group, sulfino group, sulfeno group, thiol group, thiocarboxyl group, thioformyl group, pyrrolyl group, imidazolyl group, piperidyl group, indazolyl group and carbazolyl group. When the organic carrier originally has at least one polar functional group, the organic carrier can be used as it is. One or more kinds of polar functional groups can also be introduced by subjecting the organic carrier as a matrix to a suitable chemical treatment. The chemical treatment may be any method capable of introducing one or more polar functional groups into the organic carrier. For example, it may be a reaction between acrylic polymer and polyalkylenepolyamine such as ethylenediamine, propanediamine, diethylenetriamine, tetraethylenepentamine, dipropylenetriamine or the like. As the specific method of such a reaction, for example, there is a method of treating an acrylic polymer (e.g. polyacrylonitrile) in a slurry state in a mixed solution of ethylenediamine and water at 100° C. or more, for example from 120° C. to 150° C. In certain embodiments, the amount of polar functional group per unit gram in the organic carrier having a polar functional group is from 0.01 to 50 mmol/g, or from 0.1 to 20 mmol/g.

### (B) Organoaluminoxy Compound

Organoaluminoxy compound (B) can comprise one or more organoaluminoxy compounds, including aluminoxanes and modified aluminoxanes. Non-limiting examples include cyclic aluminoxane, for example, {—Al(R¹)—O—}ₐ and/or linear aluminoxane, for example, R¹(—Al(R¹)—O—)_{b} AlR¹₂ (wherein, R¹ represents hydrogen or hydrocarbon group having 1 to about 20 carbon atoms, each R¹ may be the same or different; and each of “a” and “b” represents an integer of not less than 1).

Specific examples of R¹ include alkyl groups having from 1 to about 20 carbon atoms such as methyl, ethyl, n-propyl, isopropyl, n-butyl, isobutyl, n-pentyl, neopentyl and the like. Each of “a” and “b” represent an integer of 1 to 40, or an integer of 3 to 20.

Organoaluminoxy compound (B) can be prepared by any suitable method, including currently known methods. For example, alkylaluminoxane (B) can be prepared by dissolving at least one trialkylaluminum (e.g. trimethylaluminum, etc.) in organic solvent (e.g. toluene, aliphatic hydrocarbon, etc.). In one embodiment, the organic solvent comprises aqueous organic solvent. Suitable ratios of trialkylaluminum to organic solvent include: 0.01:1 to 10:1 (mol:mol). According to another method, alkylaluminoxane (B) can be prepared by combining at least one trialkylaluminum (e.g. trimethylaluminum, etc.) with metal salt hydrate (e.g. copper sulfate hydrate, etc.). Suitable ratios of trialkylaluminum to metal salt hydrate include, 0.01:1 to 10:1 (mol:mol). Alkylaluminoxane (B) may comprise trialkylaluminum and/or other materials, which are produced during preparation or otherwise.

### (C) Component Having at Least One Electron Withdrawing Group and at Least One Active Proton

Component having at east one electron withdrawing group and at least one active proton (C) comprises any component having at least one electron withdrawing group, for example, without limitation, aromatic component or aliphatic component having at least one electron withdrawing group, and at least one active proton.

In one embodiment component having at least one electron withdrawing group and at least one active proton (C) comprises conjugate base of the at least one active proton, wherein the conjugate base comprises monodentate donor chemically bonded to at least one electron withdrawing group. For example, component R⁴ₙXH, wherein R⁴ comprises hydrocarbon group having from 1 to 20 carbon atoms, X is O, S, N, or P, n is 1 when X is O or S, and n is 2 when X is N or P, is a suitable component having at least one electron withdrawing group and at least one active proton (O), R⁴ₙX being the conjugate base of the active proton H⁺, R⁴ being a group bearing at least one electron withdrawing group, and X being the monodentate donor in one embodiment, the conjugate base functions as a monodentate donor (e.g., RO⁻) and not as a multidentate donor (e.g., RCOO⁻), for example, R⁴ₙXH, where R⁴ is C₆F₅ and X is O, is suitable for use in this invention.

An electron withdrawing group comprises a substituent having a Hammett substituent constant σ that is positive, and examples thereof include fluoro group, chloro group, bromo group, iodo group, cyano group, nitro group, carbonyl group, sulfo group, phenyl group and the like.

Monodentate conjugate base of active proton comprises group capable of forming a chemical bond to organoaluminum compound; and examples thereof include phenoxyl group, alkoxyl group, primary amino group, secondary amino group, imino group, amide group, imide group, thiolic group and the like.

Component having at least one electron withdrawing group and at least one active proton (C) may have various and/or a plurality of electron withdrawing groups or active protons.

Specific examples of component having at least one electron withdrawing group and at least one active proton (C) include, without limitation, phenol, pentafluorophenol, 2,3,5,6-tetrafluorophenol, 2,4,6-trifluorophenol, 2,3-difluorophenol, 2,4-difluorophenol, 2,5-difluorophenol, 2,6-difluorophenol: 3,4-difluorophenol, 3,5-difluorophenol, 2-fluorophenol, 3-fluorophenol, 4-fluorophenol, 2-trifluoromethylphenol, 3-trifluoromethylphenol, 4-trifluoromethylphenol, pentafluorobenzyl alcohol, pentafluorothiophenol, 2,2,2-trifluoroethyl alcohol, 1H,1H-pentafluoro-propanol, 1,1,1,3,3,3-hexafluoro-2-propyl alcohol, pentachlorophenol, pentabromophenol, 2-chloro-4-fluorophenol, 2-bromo-4-fluorophenol, 2-bromo-4,5-difluorophenol, tetrafluorocatechol, tetrafluorohydroquinone and the like. The foregoing examples include component having at least one electron withdrawing group and at least one active proton with the monodentate donor of its conjugate base chemically bonded to at least one electron withdrawing group. In certain embodiments, halogenated phenols, e.g., fluorinated phenols, are useful. In one embodiment, pentafluorophenol is useful.

### (C′) Component Having at Least One Electron Donating Group and at Least One Active Proton

Component having at least one electron donating group and at least one active proton (C′) comprises any component having at least one electron donating group, for example, without limitation, aromatic component or aliphatic component having at least one electron donating group, and at least one active proton.

In one embodiment component having at least one electron donating group and at least one active proton (C′) comprises conjugate base of the at least one active proton, wherein the conjugate base comprises monodentate donor chemically bonded to at least one electron donating group. For example, component R⁴ₙXH, wherein R⁴ comprises hydrocarbon group having from 1 to 20 carbon atoms, X is O, S, N, or P, n is 1 when X is O or S, and n is 2 when X is N or P, is a suitable component having at least one electron donating group and at least one active proton (C′), R⁴ₙX being the conjugate base of the active proton H⁺, R⁴ being a group beating at least one electron donating group, and X being the monodentate donor. In one embodiment, the conjugate base functions as a monodentate donor (e.g., RO⁻) and not as a multidentate donor (e.g., RCOO⁻), for example, R⁴ₙXH, where R⁴ is C₆F₅ and X is O, is suitable for use in this invention.

An electron donating group comprises a substituent having a Hammett substituent constants that is negative, and examples thereof include alkyl group, aryl group, alkoxy group, aryloxy group, or fused aryl ring, any of which having up to about 10 carbon atoms, and the like.

Monodentate conjugate base of active proton comprises group capable of forming a chemical bond to organoaluminum compound; and examples thereof include phenoxyl group, alkoxyl group, primary amino group, secondary amino group, imino group, amide group, imide group, thiolic group and the like.

Component having at least one electron donating group and at least one active proton (C′) may have various and/or a plurality of electron donating groups or active protons.

Specific examples of component having at least one electron donating group and at least one active proton (C′) include, without limitation, 2,6-dimethylphenol, 2,6-isodipropylphenol, 2,6-t-dibutyl-4-methylphenol, 2-t-butyl-6-methylphenol, 2-phenoxyphenol, 2-t-butylphenol, 2-isopropylphenol and the like and the like. The foregoing examples include component having at least one electron donating group and at least one active proton with the monodentate donor of its conjugate base chemically bonded to at least one electron donating group. In one embodiment, 2,6-dimethylphenol is useful.

### (D) Lewis Base

Lewis base (D) can comprise primary amine, secondary amine, or tertiary amine NR²₃, or any mixture thereof, wherein R² in each occurrence is selected independently from hydrocarbyl group having up to about 20 carbon atoms, or hydrogen. For example, Lewis base (D) can comprise a variety of amines, including, but not limited to, NMe₂Ph, NMe₂(CH₂Ph), NEt₂Ph, NEt₂(CH₂Ph), or Lewis base (D) can comprise one or more long chain amines such as NMe(CₙH₂ₙ₊₁)(CₘH₂ₘ₊₁), NMe₂(CₙH₂ₙ₊₁), NEt(CₙH₂ₙ₊₁)(CₘH₂ₘ₊₁), or NEt₂(CₙH₂ₙ₊₁), wherein n and m are selected independently from an integer from about 3 to about 20. Examples of long chain amines of the formula NMe(CₙH₂ₙ₊₁)(CₘH₂ₘ₊₁) include, but are not limited to, compounds such as NMe(C₁₆H₃₃)₂, NMe(C₁₇H₃₅)₂, NMe(C₁₈H₃₇)₂, NMe(C₁₆H₃₃)(C₁₇H₃₅), NMe(C₁₆H₃₃)(C₁₈H₃₇), NMe(C₁₇H₃₅)(C₁₈H₃₇), and the like. For example, NMe(C₁₆H₃₃)₂ is typically the major species in a commercial long chain amine composition that usually comprises a mixture of several amines. In one embodiment, Lewis base (D) comprises NMe₂Ph, NMe₂(CH₂Ph), NEt₂Ph, NEt₂(CH₂Ph), NMe(C₁₆CH₃₃)₂. Lewis base (D) can also comprise phosphines,

### (E) Ionic Compound Having at Least One Active Proton

In one embodiment, ionic compound having at least one proton (E) is derived from at least Lewis base (D) and component having at least one electron withdrawing group and at least one active proton (C).

### (F) Transition Metal Component

Transition metal component (F) can comprise any alkylated transition metal component having olefin polymerization potential. For example, without limitation, transition metal component (F) can comprise one or more metallocene transition metal components.

Transition metal component (F) can comprise alkylated catalyst precursor MLₐ Rₙ₋ₐ (wherein M represents transition metal atom of the 4th Group or Lanthanide Series of the Periodic Table of Elements (1993, IUPAC), and examples thereof include transition metals of the 4th Group of the Periodic Table, such as titanium atom, zirconium atom and hafnium atom and transition metals of the Lanthanide Series, such as samarium; L represents group having cyclopentadienyl skeleton or group having at least one hetero atom, at least one L being group having cyclopentadienyl skeleton, and a plurality of L may be the same or different and may be crosslinked to each other, represents hydrocarbon group having 1 to about 20 carbon atoms; “a” represents a numeral satisfying the expression 0<a≦n; and n represents valence of transition metal atom M).

In L in transition metal component (F), group having cyclopentadienyl skeleton can comprise, for example, cyclopentadienyl group, substituted cyclopentadienyl group or polycyclic group having cyclopentadienyl skeleton. Example substituted cyclopentadienyl groups include hydrocarbon group having 1 to about 20 carbon atoms, halogenated hydrocarbon group having 1 to about 20 carbon atoms, silyl group having 1 to about 20 carbon atoms and the like. Silyl group according to this invention can include SiMe₃ and the like. Examples of polycyclic group having cyclopentadienyl skeleton include indenyl group, fluorenyl group and the like. Examples of hetero atom of the group having at least one hetero atom include nitrogen atom, oxygen atom, phosphorous atom, sulfur atom and the like.

Example substituted cyclopentadienyl groups include methylcyclopentadienyl group, ethylcyclopentadienyl group, n-propylcyclopentadienyl group, n-butylcyclopentadienyl group, isopropylcyclopentadienyl group, isobutylcyclopentadienyl group, sec-butylcyclopentadienyl group, tertbutylcyclopentadienyl group, 1,2-dimethylcyclopentadienyl group, 1,3-dimethylcyclopentadienyl group, 1,2,3-trimethylcyclopentadienyl group, 1,2,4-methylcyclopentadienyl group, tetramethylcyclopentadienyl group, pentamethylcyclopentadienyl group and the like.

Example polycyclic groups having cyclopentadienyl group include indenyl group, 4,5,6,7-tetrahydroindenyl group, fluorenyl group and the like.

Example groups having at least one hetero atom include methylamino group, tert-butylamino group, benzylamino group, methoxy group, tert-butoxy group, phenoxy group, pyrrolyl group, thiomethoxy group and the like.

One or more groups having cyclopentadienyl skeleton, or one or more group having cyclopentadienyl skeleton and one or more group having at least one hetero atom, may be crosslinked with (i) alkylene group such as ethylene, propylene and the like; (ii) substituted alkylene group such as isopropylidene, diphenylmethylene and the like; or (iii) silylene group or substituted silylene group such as dimethylsilylene group, diphenylsilylene group, methylsilylsilylene group and the like.

R in transition metal component (F) comprises hydrogen or hydrocarbon group having 1 to about 20 carbon atoms. Examples of R include alkyl group having 1 to about 20 carbon atoms such as methyl group, ethyl group, n-propyl group, isopropyl group, n-butyl group, benzyl group and the like.

Examples of transition metal component (F) MLₐ Rₙ₋ₐ, wherein M comprises zirconium, include bis(cyclopentadienyl)zirconiumdimethyl, bis(methylcyclopentadienyl)zirconiumdimethyl, bis(pentamethylcyclopentadienyl)zirconiumdimethyl, bis(indenyl)zirconiumdimethyl, bis(4,5,6,7-tetrahydroindenyl)zirconiumdimethyl, bis(fluorenyl)zirconiumdimethyl, ethylenebis(indenyl)zirconiumdimethyl, dimethylsilylene(cyclopentadienylfluorenyl)zirconiumdimethyl, diphenylsilylenebis(indenyl)zirconiumdimethyl, cyclopentadienyldimethylaminozirconiumdimethyl, cyclopentadienylphenoxyzirconium dimethyl, dimethyl(tert-butylamino)(tetramethylcyclopentadienyl) silanezirconiumdimethyl, isopropylidene(cyclopentadienyl)(3-tert-butyl-5-methyl-2-phenoxy)zirconiumdimethyl, dimethylsilylene(tetramethylcyclopentadienyl)(3-tertbutyl-5-methyl-2-phenoxy)zirconiumdimethyl and the like.

Additional exemplary transition metal component (F) MLₐ Rₙ₋ₐ include components wherein zirconium is replaced with titanium or hafnium in the above zirconium components.

Other alkylated catalyst precursors useful in this invention are: rac-dimethylsilylbis(2-methyl-4-phenyl-indenyl)zirconium dimethyl (M1), rac-dimethylsilylbis-(2-methyl-1-indenyl)zirconium dimethyl (M2); rac-dimethylsilylbis(2-methyl-4,5-benzoindenyl)zirconium dimethyl (M3); ethylenebis(tetrahydroindenyl)zirconium dimethyl (M4) ethylenebis(indenyl)zirconium dimethyl (M5), rac-dimethylsilylbis(4,5,6,7-tetrahydroindenyl)zirconium dimethyl (M6); bis(1,3-dimethylcyclopentadienyl)zirconium dimethyl (M7), and 1-(9-fluorenyl)-1-(cyclopentadienyl)-1-(methyl)-1-(but-3-enyl)methane zirconium dimethyl (M8). Alkylated catalyst precursor can be generated in-situ through reaction of alkylation agent with the halogenated version of the catalyst precursor. For example, bis(cyclopentadienyl)zirconium dichloride can be treated with triisobutylaluminum (TIBA) and then combined with activator composition (G).

### (G) Activator Composition

### —Aspect One

Activator composition (G)—ASPECT ONE comprises carrier (A), organoaluminoxy compound (B), Lewis base (D), and component having at least one electron withdrawing group and at least one active proton (C). In one embodiment, activator composition (G)—ASPECT ONE is derived from carrier (A), organoaluminoxy compound (B), Lewis base (D), and component having at least one electron withdrawing group and at least one active proton (C) combined in any order. In one embodiment, activator composition (G)—ASPECT ONE is obtained by combining carrier (A) with organoaluminoxy compound (B), followed by combining with Lewis base (D) and component having at least one electron withdrawing group and at least one active proton (C).

In one embodiment, the combining is conducted in an inert gas atmosphere; the temperature is from −80° C. to 200° C., or from 0° C., to 120° C.; the combining time is from about 1 minute to about 36 hours, or from about 10 minutes to about 24 hours. Solvent used for preparing activator composition (G)—ASPECT ONE comprises aliphatic solvent or aromatic solvent, either of which is inert to carrier (A), organoaluminoxy compound (B), component having at least one electron withdrawing group and at least one active proton (C), and Lewis base (D). Example treatments after completion of the combining operation include filtration of supernatant, followed by washing with inert solvent and evaporation of solvent under reduced pressure or in inert gas flow, but these treatments are not required. Resulting activator composition (G)—ASPECT ONE can be used for polymerization in any suitable state, including fluid, dry, or semi-dry powder, and may be used for polymerization in the state of being suspended in inert solvent. In one embodiment, the combining of carrier (A) with organoaluminoxy compound (B) and component having at least one electron withdrawing group and at least one active proton (C) is conducted at ambient temperature and the combining time is from 15 minutes to 48 hours. At least a portion of resulting product is combined with Lewis base (D).

In certain embodiments, the amount of aluminum atom in alkylaluminoxane (B) in product, e.g., solid component, obtained by combining carrier (A) with alkylaluminoxane (B) is not less than about 0.1 mmol aluminum atom, or not less than about 1 mmol aluminum atom, in 1 g of the solid component in the dry state. In certain embodiments, when solid component obtained by combining carrier (A) with alkylaluminoxane (B) is combined with component having at least one electron withdrawing group and at least one active proton (C), the molar ratio of active proton of (C) to aluminum atom of alkylaluminoxane (B) in the solid component is from about 0.02 to about 1, or from about 0.05 to about 0.5, or from about 0.1 to about 0.3.

### —Aspect Two

Activator composition (G)—ASPECT TWO comprises carrier (A), organoaluminoxy compound (B), component having at least one electron withdrawing group and at least one active proton (C), and ionic compound having at least one active proton (E). In one embodiment, activator composition (G)—ASPECT TWO is derived from carrier (A), organoaluminoxy compound (B), component having at least one electron withdrawing group and at least one active proton (C), and ionic compound having at least one active proton (E) combined in any order.

In one embodiment, the combining is conducted in an inert gas atmosphere, the temperature is from −80° C. to 200° C., or from 0° C. to 120° C.; the combining time is from about 1 minute to about 36 hours, or from about 10 minutes to about 24 hours. Solvent used for preparing activator composition (G)—ASPECT TWO comprises aliphatic solvent or aromatic solvent, either of which is inert to carrier (A), organoaluminoxy compound (B), component having at least one electron withdrawing group and at least one active proton (C), and ionic compound having at least one active proton (E). Example treatments after completion of the combining operation include filtration of supernatant followed by washing with inert solvent and evaporation of solvent tinder reduced pressure or in inert gas flow, but these treatments are not required Resulting activator composition (G)—ASPECT TWO can be used for polymerization in any suitable state, including fluid, dry, or semi-dry powder, and may be used for polymerization in the state of being suspended in inert solvent. In one embodiment, the combining of carrier (A) with organoaluminoxy compound (B) and component having at least one electron withdrawing group and at least one active proton (C) is conducted at ambient temperature and the combining time is from 15 minutes to 48 hours. At least a portion of resulting product is combined with ionic compound having at least one active proton (E).

In certain embodiments, the amount of aluminum atom in alkylaluminoxane (B) in product, e.g., solid component, obtained by combining carrier (A) with alkylaluminoxane (B) is not less than about 0.1 mmol aluminum atom, or not less than about 1 mmol aluminum atom, in 1 g of the solid component in the dry state. In certain embodiments, when solid component obtained by combining carrier (A) with alkylaluminoxane (B) is combined with component having at feast one electron withdrawing group and at least one active proton (C) and with ionic compound having at least one active proton (E), the molar ratio of active proton of (C) to aluminum atom of alkylaluminoxane (B) in the solid component is from about 0.02 to about 1 or from about 0.35 to about 0.5, or from about 0.1 to about 0.3.

### —Aspect Three

Activator composition (G)—ASPECT THREE comprises carrier (A), organoaluminoxy compound (B), Lewis base (D), and component having at least one electron donating group and at least one active proton (C′). In one embodiment, activator composition (G)—ASPECT THREE is derived from carrier (A), organoaluminoxy compound (B), Lewis base (D) and component having at least one electron donating group and at least one active proton (C′) combined in any order. In one embodiment, activator composition (G)—ASPECT THREE is obtained by combining carrier (A) with organoaluminoxy compound (B), followed by combining with Lewis base (9) and component having at least one electron donating group and at least one active proton (C′).

In one embodiment, the combining is conducted in an inert gas atmosphere; the temperature is from −80° C. to 200° C., or from 0° C. to 120° C.; the combining time is from about 1 minute to about 36 hours, or from about 10 minutes to about 24 hours. Solvent used for preparing activator composition (G)—ASPECT THREE comprises aliphatic solvent or aromatic solvent, either of which is inert to carrier (A), organoaluminoxy compound (B), component having at least one electron donating group and at least one active proton (C), and Lewis base (D). Example treatments after completion of the combining operation include filtration of supernatant, followed by washing with inert solvent and evaporation of solvent under reduced pressure or in inert gas flow, but these treatments are not required. Resulting activator composition (G)—ASPECT THREE can be used for polymerization in any suitable state, including fluid, dry, or semi-dry powder, and may be used for polymerization in the state of being suspended in inert solvent. In one embodiment, the combining of carrier (A) with organoaluminoxy compound (B) and component having at least one electron donating group and at least one active proton (C′) is conducted at ambient temperature and the combining time is from 15 minutes to 48 hours. At least a portion of resulting product is combined with Lewis base (D).

In certain embodiments, the amount of aluminum atom in alkylaluminoxane (B) in product, e.g., solid component, obtained by combining carrier (A) with alkylaluminoxane (B) is not less than about 0.1 mmol aluminum atom, or not less than about 1 mmol aluminum atom, in 1 g of the solid component in the dry state. In certain embodiments, when solid component obtained by combining carrier (A) with alkylaluminoxane (B) is combined with component having at least one electron donating group and at least one active proton (C′), the molar ratio of active proton of (C′) to aluminum atom of alkylaluminoxane (B) in the solid component is from about 0.02 to about 12 or from about 0.05 to about 0.5, or from about 0.1 to about 0.3.

### —Aspect Four

Activator composition (G)—ASPECT FOUR comprises carrier (A), organoaluminoxy compound (B), component having at least one electron withdrawing group and at least one active proton (C), and component having at least one electron donating group and at least one active proton (C′). In one embodiment, activator composition (G)—ASPECT FOUR comprises carrier (A), organoaluminoxy compound (B), Lewis base (D), component having at least one electron withdrawing group and at least one active proton (C), and component having at least one electron donating group and at least one active proton (C′). In one embodiment, activator composition (G)—ASPECT FOUR is derived from carrier (A), organoaluminoxy compound (B), component having at least one electron withdrawing group and at least one active proton (C), and component having at least one electron donating group and at least one active proton (C′) combined in any order. In one embodiment, activator composition (G)—ASPECT FOUR is derived from carrier (A), organoaluminoxy compound (B), Lewis base (D), component having at least one electron withdrawing group and at least one active proton (C), and component having at least one electron donating group and at least one active proton (C′) combined in any order. In one embodiment, activator composition (G)—ASPECT FOUR is obtained by combining carrier (A) with organoaluminoxy compound (B), followed by combining with Lewis base (D), component having at least one electron withdrawing group and at least one active proton (C), and component having at least one electron donating group and at least one active proton (C′).

In one embodiment, the combining is conducted in an inert gas atmosphere; the temperature is from −80° C. to 200° C., or from 0° C. to 120° C.; the combining time is from about 1 minute to about 36 hours, or from about 10 minutes to about 24 hours. Solvent used for preparing activator composition (G)—ASPECT FOUR comprises aliphatic solvent or aromatic solvent, either of which is inert to carrier (A), organoaluminoxy compound (B), component having at feast one electron withdrawing group and at least one active proton (C), component having at least one electron donating group and at least one active proton (C), and Lewis base (D). Example treatments after completion of the combining operation include filtration of supernatant, followed by washing with inert solvent and evaporation of solvent under reduced pressure or in inert gas flow, but these treatments are not required. Resulting activator composition (G)—ASPECT FOUR can be used for polymerization in any suitable state, including fluid, dry, or semi-dry powder, and may be used for polymerization in the state of being suspended in inert solvent. In one embodiment, the combining of carrier (A) with organoaluminoxy compound (B), component having at least one electron withdrawing group and at least one active proton (C), and component having at least one electron donating group and at least one active proton (C′) is conducted at ambient temperature and the combining time is from 15 minutes to 48 hours. In certain embodiments, at least a portion of resulting product is combined with Lewis base (D).

In certain embodiments, the amount of aluminum atom in alkylaluminoxane (B) in product, e.g., solid component, obtained by combining carrier (A) with alkylaluminoxane (B) is not less than about 0.1 mmol aluminum atom, or not less than about 1 mmol aluminum atom, in 1 g of the solid component in the dry state. In certain embodiments, when solid component obtained by combining carrier (A) with alkylaluminoxane (B) is combined with component having at least one electron withdrawing group and at least one active proton (C) and with component having at least one electron donating group and at least one active proton (C′), the molar ratio of active proton of (C) and (C′) to aluminum atom of alkylaluminoxane (B) in the solid component is from about 0.02 to about 1, or from about 0.05 to about 0.5, or from about 0.1 to about 0.3.

### (H) Catalyst for Olefin Polymerization

In one embodiment, activator composition (G) and transition metal component (F) are each added independently, yet substantially simultaneously, to monomer to catalyze polymerization. In another embodiment, activator composition (G) and transition metal component (F) are combined to form product and at least a portion of product is added to monomer to catalyze polymerization. In either embodiment the active proton ratio of activator composition (G) to transition metal atom of transition metal component (F) is 0.1 to 4, or 0.5 to 2, or almost 1.

Activator composition (G) is adapted to activate transition metal component (F) by Brønsted acidity, i.e., by protonating alkylated transition metal component (F). Activator composition (G) is also adapted to activate transition metal component (F) by Lewis acidity, i.e., by accepting at least one electron pair from transition metal component (F). In one embodiment, the amount of activator composition (G) combined with transition metal component (F) is sufficient to allow activation of transition metal component (F) predominantly by Brønsted acidity; e.g., 30% or more, 70% or more, or 90% or more of activation occurs due to Brønsted acidity. In one embodiment, the amount of activator composition (G) combined with transition metal component (F) is sufficient to allow activation of transition metal component (F) substantially by Brønsted acidity) e.g., 95% or more, or 98% or more of activation occurs due to Brønsted acidity. In these embodiments, activator composition (G) is combined with transition metal component (F) either before combining with monomer or while simultaneously combining with monomer. Given a known activator composition (G) and a known transition metal component (F), one skilled in the art can determine the amount of the activator composition (G) to combine with transition metal component (F) to allow activation predominantly or substantially by Brønsted acidity.

### (I) Polymerization

In the present invention, any olefin or diolefin having 2 to 20 carbon atoms can be used as a monomer for polymerization. Specific examples thereof include ethylene, propylene, butene-1, pentene-1, hexene-1, heptene-1, octene-1 nonene-1, decene-1, hexadecene-1, eicocene-1,4-methylpentene-1,5-methyl-2-pentene-1, vinylcyclohexane, styrene, dicyclopentadiene, norbornene, 5-ethylidene-2-norbornene and the like, but are not limited thereto. In the present invention, copolymerization can be conducted using two or more monomers, simultaneously. Specific examples of the monomers constituting the copolymer include ethylene/an α olefin such as ethylene/propylene, ethylene/butene-1, ethylene/hexene-1 ethylene/propylene/butene-1, ethylene/propylene/5-ethylidene-2-norbornene and the like, propylene/butene-1, and the like, but are not limited thereto.

The polymerization method is not limited, and both liquid phase polymerization method and gas phase polymerization method can be used. Examples of solvent used for liquid phase polymerization include aliphatic hydrocarbons such as butane, pentane, heptane, octane and the like; aromatic hydrocarbons such as benzene, toluene and the like; and hydrocarbon halides such as methylene chloride and the like. It is also possible to use at least a portion of the olefin to be polymerized as a solvent. The polymerization can be conducted in a batch-wise, semibatch-wise or continuous manner, and polymerization may be conducted in two or more stages which differ in reaction conditions. The polymerization temperature can be from about −50° C. to about 200° C., or from 0° C. to about 100° C. The polymerization pressure can be from atmospheric pressure to about 100 kg/cm², or from atmospheric pressure to about 50 kg/cm². Appropriate polymerization time can be determined by means known to those skilled in the art according to the desired olefin polymer and reaction apparatus, and is typically within the range from about 1 minute to about 20 hours. In the present invention, a chain transfer agent such as hydrogen may be added to adjust the molecular weight of olefin polymer to be obtained in polymerization.

In certain embodiments of this invention, organoaluminum compound can be added during polymerization to remove impurities, such as water. Organoaluminum compound useful herein can comprise a variety of organoaluminum compounds, including at least one currently known organoaluminum compound, for example, organoaluminum compound R³_{c} AlY_{3-c} (wherein R³ represents a hydrocarbon group having 1 to about 20 carbon atoms; Y represents hydrogen atom and/or halogen atoms; and “c” represents an integer of 0 to 3). Specific examples of R³ include methyl group, ethyl group, n-propyl group, n-butyl group, isobutyl group, n-hexyl group and the like. Specific examples of the halogen atom for Y include fluorine atom, chlorine atom, bromine atom and iodine atom. Specific examples of the organoaluminum compound R³_{c} AlY_{3-c} include trialkylaluminums such as trimethylaluminum, triethylaluminum, tri-n-propylaluminum, triisobutylaluminum tri-n-hexylaluminum and the like; dialkylaluminum chloride such as dimethylaluminum chloride, diethylaluminum chloride, di-n-propylaluminum chloride, diisobutylaluminum chloride, di-n-hexylaluminum chloride and the like; alkylaluminum dichlorides such as methylaluminumdichloride, ethylaluminum dichloride, n-propylaluminum dichloride, isobutylaluminum dichloride, n-hexylaluminum dichloride and the like; and dialkylaluminum hydrides such as dimethylaluminum hydride, diethylaluminum hydride, di-n-propylaluminum hydride, diisobutylaluminum hydride, di-n-hexylaluminum hydride and the like.

### EXAMPLES

The present invention can be further illustrated by the following examples, which are not to be construed in any way as imposing limitations upon the scope thereof. On the contrary, it is to be clearly understood that resort may be had to various other aspects, embodiments, modifications, and equivalents thereof which, after reading the description herein, may suggest themselves to one of ordinary skill in the art without departing from the spirit of the present invention or the scope of the appended claims.

General procedures used in preparing, characterizing, and using the compounds and compositions of this invention can be as follows. Preparations and analytical procedures related to air-sensitive compounds and compositions, including air-sensitive silica compounds, can be performed under a dry nitrogen atmosphere (<2 ppm O₂), either in a nitrogen-filled drybox or using standard Schlenk line techniques. Aluminum alkyl compounds used, including methylaluminoxane (MAO), ethylaluminoxane (EAO), isobutylaluminoxane (IBAO), trimethylaluminum (TMA), triethylaluminum (TEA), and triisobutylaluminum (TIBA), can be commercial products of Albemarle Corporation and can be used as received. Substituted phenol reagents such as 2,6-Me₂PhOH, 2,6-i-Pr₂PhOH, 2,6-t-Bu₂-4-MePhOH, 2-t-Bu-6-MePhOH, 2-PhPhOH, 2-t-BuPhOH, and the like can be purchased from Aldrich Chemical Company (Milwaukee, Wis.) and can be used as received without further purification. Toluene, ethylene, isobutene, 1-hexene, and nitrogen used in the polymerization reactions can be purified by passing through a series of three cylinders as follows: molecular sieves, OXYCLEAR oxygen absorbent, and alumina. Ethylene can be polymer grade obtained from Matheson. Isohexane and toluene for activator and catalyst preparation and spectroscopy studies can be Albemarle production anhydrous grade, which have been stored over sodium-potassium (Na/K) alloy, Hexane, C₆D₆, and similar hydrocarbon solvents can be Aldrich anhydrous grade: which have been dried with and stored over Na/K alloy.

The FT-infrared spectra can be recorded on a NICOLET MAGNA-IR 560 spectrometer with a DRIFTS accessory under inert atmosphere, using a diffuse reflectance method. Samples can be prepared by loading, in the drybox under an inert atmosphere, a dry, solid silica compound in an inert cell with KBr windows, NMR studies can be undertaken on a BRUKERDPX 40 (400 MHz) instrument, with the NMR instrumental parameters set up for both quantitative and qualitative measurements. Total Al content on silica can be determined using standard inductively Coupled Plasma (ICP) emission spectroscopy techniques.

The metallocenes used in the following examples can be prepared according to procedures given in the literature. The following treatises describe such methods: Wailes, P. C.; Coutts, R. S. P.; Weigold, H. in Organometallic Chemistry of Titanium, Zirconium, and Hafnium; Academic Press; New York, 1974; Cardin, D. J.; Lappert, M. F.; and Raston, C, L. Chemistry of Organo-Zirconium and -Hafnium Compounds; Halstead Press; New York, 1986; Cardin, D. J.; Lappert, M. F.; Raston, C. L.; and Riley, P. I. Cyclopentadienyl and other Anionic π-Ligand Complexes of Zirconium and Hafnium; in Comprehensive Organometallic Chemistry: The Synthesis, Reactions, and Structures of Organometallic Compounds; ed. Wilkinson, G.; Stone, F. G. A.; and Abel, E. W; Pergamon Press; Oxford, 1982; Bottrill, M., Gavens, P. D.; Kelland, J. W.; and McMeeking, J.; Anionic π-Bonded Derivatives of Titanium; in Comprehensive Organometallic Chemistry: The Synthesis, Reactions, and Structures of Organometallic Compounds; ed. Wilkinson, G.; Stone, F. G. A., and Abel, E. W.; Pergamon Press; Oxford; 1982.

Various silica samples that were used, or that could be used, to prepare the activator and the catalyst composition of this invention are presented in the following Table 1, along with some analytical data characterizing these silicas. This disclosure is not intended to be limiting, but rather illustrative of the range of silica properties that could be used in the practice this invention. Silica I is a sample of silica sold under the trade name GRACE 952, Silica II is a sample of silica obtained from Ineos that is sold under the trade name ES70, and Silica III is a sample of silica sold under the trade name Grace 948 (manufactured by W. R. Grace & Co.). Further, supports that could be used in the practice of this invention include any metal oxide or support as disclosed herein.

TABLE 1
Properties of Representative Silica Samples.

| | | | Max or | | |
|---|---|---|---|---|---|
| | Surface | Pore | Ave. Pore | | |
| | Area | Volume | Diameter | Average Particle Sizes | Weight Loss (%) |
| Silica | (m²/g) | (cc/g) | (nm) | (μm) (%) | (Temp, ° C.) |
| Silica I | 275 | 1.53 | 22.3 | Overall Avg. 34.1; | 4.00 (LOD), |
| | | | | 14.8 (10), 30.9 (50), | 6.57 (LOI) (raw) |
| | | | | 57.3 (90) | TGA: 3.56 (200° C.), |
| | | | | | 5.69 (1000° C.) |
| Silica II | 312 | 1.58 | 23 (10-30) | Overall Avg. 38.6; | (500° C.) |
| | (1- | | | 11.2 (10), 75.9 (90) | (max 8) |
| | point) | | | | |

### —Aspect One

Table 2 is referenced in the following examples,

TABLE 2
Ethylene Polymerization Performance of Supported M1 and M2

| | | | AO on | | | | Activity |
|---|---|---|---|---|---|---|---|
| | Catalyst | C₆F₅OH | SiO₂ | PhNMe₂ | Zr | Productivity | (kg/mol |
| Entry | Precursor | (mol %)¹ | (Al %) | (mol %)¹ | (wt %) | (g/g cat/hr) | Zr/hr) |
| 1 | M1 | 23 | EAO-m | 12.5 | 0.40 | 4,000 | 91,200 |
| | | | 11.5 | | | | |
| 2 | M1 | 22 | EAO-m | 0 | 0.27 | 2,000 | 67,600 |
| | | | 12.5 | | | | |
| 3 | M1 | 50 | EAO³ | 5.0 | 0.40 | 4,100 | 93,300 |
| | | | 9.74 | | | | |
| 4 | M1 | 50 | EAO³ | 0 | 0.34 | 3,200 | 85,900 |
| | | | 9.74 | | | | |
| 5 | M2 | 29 | EAO | 3.3 | 0.49 | 4,600 | 111,300 |
| | | | 9.05 | | | | |
| 6 | M2 | 30 | EAO | 0 | 0.42 | 3,500 | 78,000 |
| | | | 9.05 | | | | |
| 7 | M1 | 0 | EAO | 0 | 0.37 | 400 | 9,900 |
| | | | 9.05 | | | | |
| 8 | M1 | 0 | EAO-m | 0 | 0.30² | 262 | 8,000 |
| | | | 11.5 | | | | |

¹Charge based on Al on silica;
²Charge based on total mass
³ES70 silica

### Aluminoxanes

### Example 1

### Aspect One—EAO (Ethylaluminoxane)

A 1 L jacketed reactor was equipped with overhead stirrer, thermocouple, nitrogen purge and gas outlet. Triethylaluminum (TEA) 114.4 g was mixed with toluene 348.2 g to form a solution in an aluminum alkyl container and 462.6 g of this solution was charged in the nitrogen-purged jacketed reactor. The agitation speed of the stirrer was set at 400 rpm. The cooling fluid in reactor jacket was set to −20° C. and the reaction solution was cooled to 20° C. before water addition. Syringe pump was used to feed deionized H₂O (16.3 g) into the reactor slowly. The temperature of reaction solution was maintained between −7 to −20° C. The reactor was warmed back to 25° C. slowly after water feeding and kept at 25° C. for 1 h. The reaction was finished and the top layer of clear solution was decanted into a dried bottle. The bottle of ethylaluminoxane solution was brought into nitrogen-purged glovebox for further use. The typical Al content in the final product was 5.68%.

### Example 2

### Aspect One—EAO-m (Ethylaluminoxane)

The same equipment and procedure were used as in Example 1—ASPECT ONE to prepare EAO-m. TEA 99.3 g and triisobutylaluminum (TIBA) 19.2 g were mixed with toluene (347.6 g) to form a solution containing about 90 mol % TEA and 10 mol % TIBA. Deionized H₂O (17.4 g) was fed into the reactor slowly. The typical Al content in the final product was 5.66%.

### Aluminoxane Coated Silicas

### Example 3

### Aspect One—EAO Coated Silica

The silica used in the preparation was either Silica I—Grace 952 (manufactured by W. R. Grace & Co.) or Silica II—ES70 (manufactured by INEOS Silicas). For each silica, BET (multiple point) surface area was about 300 m²/g and pore volume was about 1.5 ml/g. The silica was calcined in an oven at 60° C. for 4 hours and the hot silica was placed under vacuum and transferred into the glovebox.

In the glovebox, 20.0 g of the 600° C.-calcined silica was placed in a flask with 80 g dry toluene. Then a solution of EAO in toluene 60 g (3.41 g Al, based on about 11% Al in the final product) was slowly added to the silica under stirring. The slurry was then heated to 100° C. and maintained at 100° C. for 3 hr. The string was stopped and the mixture was cooled at ambient temperature for 2 hr. The mixture was then filtered through a coarse frit, washed with 3×30 ml isohexane, and dried under vacuum overnight. 26.9 g of product was obtained (Two similar preparations gave Al loading 9.05 wt % and 9.74 wt %, respectively). This sample was analyzed by IR, see FIG. 1 spectrum a.

### Example 4

### Aspect One—EAO-m Coated Silica

The silica used in the preparation was either Silica I—Grace 952 (manufactured by W. R. Grace & Co.) or Silica II—ES70 (manufactured by INEOS Silicas). For each silica, BET (multiple point) surface area was about 300 m²/g and pore volume was about 1.5 ml/g. The silica was calcined in an oven at 600° C. for 4 hours and the hot silica was placed under vacuum and transferred into the glovebox. In the glovebox, 20.0 g of the 600° C.-calcined silica was placed in a flask with 80 g dry toluene. Then a solution of EAO-m in toluene 70 g (3.96 g Al, based on ˜13% Al in the final product) was slowly added to the silica under stirring. The slurry was then heated to 100° C. and maintained at 100° C. for 3 hr. The stirring was stopped and the mixture was cooled at ambient temperature for 40 min. The mixture was then filtered through a coarse frit, washed three times with 30 ml isohexane, and dried under vacuum for 90 min. 33.2 g of product was obtained (Two similar preparations gave Al loading 11.45 wt % and 12.45 wt %, respectively).

### Supported Catalysts

### Example 5

### Aspect One—EAO-m/Silica/C₆F₅OH/Amine/M1

In the glovebox, 1.0 g EAO-m coated silica (containing 4.24 mmol Al) from Example 4—ASPECT ONE and 3.0 g toluene were charged to a 20 mL vial and the mixture was mixed well. 0.18 g (0.98 mmol) C₆F₅OH and 0.9 g toluene were charged to a 4 mL vial. The phenolic alcohol solution was then slowly added to the EAO-M coated silica slurry. The slurry was then placed on a shaker to shake for 90 min. Then 0.064 g (0.53 mmol) PhNMe₂ was added to the mixture and the resulting slurry was shaken for another 30 min. The mixture was then filtered through a coarse frit, washed two times with 39 toluene, and dried under vacuum for 30 seconds. The wet solid was transferred back to the 20 mL vial. To the wet solid was added 3.0 g toluene and 20 mg M1 solid (48 μmol), followed by vigorous shaking on a shaker for 60 min. The mixture was then filtered through a coarse frit washed three times with 3 g toluene and one time with 3 g isohexane, and dried under vacuum for 60 min, giving a 1.11 g yield. Al: 10.1%; Zr: 0.40% (Table 2, Entry 1).

### Example 6

### Aspect One—EAO-m/Silica/C₆F₅OH/M1

In the glovebox, 3.0 g EAO coated silica (containing 13.8 mmol Al) obtained from procedures similar to Example 4—ASPECT ONE and 8.7 g toluene were charged to a 20 mL vial and the mixture was mixed well. 0.56 g (3.04 mmol) C₆F₅OH and 1.1 g toluene were charged to a 4 mL vial. The phenolic alcohol solution was then slowly added to the BAG-M coated silica slurry. The slurry was then placed on a shaker to shake for 25 min. The mixture was then filtered through a coarse frit, washed two times with 15 mL toluene and one time with 20 mL isohexane, and dried under vacuum for 10 min. The wet solid was transferred back to the 20 mL vial. To the wet solid was added 8.0 g toluene and 51 mg M1 solid (123 mmol), followed by vigorous shaking on a shaker for 60 min. The mixture was then filtered through a coarse frit, washed two times with 10 mL toluene and one time with 15 mL isohexane, and dried under vacuum for 45 min, giving a 3.32 g yield. Al: 10.2%; Zr: 0.27% (Table 2, Entry 2).

### Example 7

### Aspect One—EAO/Silica/C₆F₅OH/Amine/M1

(I) In the glovebox, 1.0 g EAO coated silica (containing 3.6 mmol Al) obtained from procedures similar to Example 3—ASPECT ONE and 4.0 g toluene were charged to a 20 mL vial and the mixture was mixed well, 0.33 g (1.79 mmol) C₆F₅OH, 24 mg PhNMe₂ (0.20 mmol), and 2.0 g toluene were charged to a 4 mL vial. The phenolic alcohol solution was then slowly added to the EAO coated silica slurry. The slurry was then placed on a shaker to shake for 45 min. The mixture was then filtered through a coarse frit, washed three times with 2 mL isohexane, and dried under vacuum for 30 min. The dry solid was transferred back to the 20 mL vial. (This sample was analyzed by IR, see FIG. 1 spectrum c, and FIG. 2 spectrum c.)

(II) 4.0 g toluene and 17 mg M1 solid (41 μmol) were added to the wet solid, followed by vigorous shaking on a shaker for 60 min. The mixture was then filtered through a coarse fit, washed two times with 2 mL toluene and three times with 2mL isohexane, and dried under vacuum for 60 min Al: 7.7%; Zr: 0.40% (Table 2, Entry 3). (This sample was analyzed by IR, see FIG. 1 spectrum d, and FIG. 2 spectrum d.)

### Example 8

### Aspect One—EAO/Silica/C₆F₅OH/M1

(I) in the glovebox, 1.0 g EAO coated silica (containing 3.6 mmol Al) from procedures similar to Example 3—ASPECT ONE and 4.0 g toluene were charged to a 20 mL vial and the mixture was mixed well. 0.20 g (1.09 mmol) C₆F₅OH and 2.0 g toluene were charged to a 4 mL vial. The phenolic alcohol solution was then slowly added to the EAO coated silica slurry over 7 min. The slurry was then placed on a shaker to shake for 10 min. The mixture was then filtered through a coarse frit, washed three times with 2 mL isohexane, and dried under vacuum for 30 min. The dry solid was transferred back to the 20 mL vial. (This sample was analyzed by IR, see FIG. 1 spectrum b, and FIG. 2 spectrum b.)

(II) 4.0 g toluene and 17 mg M1 solid (41 μmol) were added to the wet solid, followed by vigorous shaking on a shaker for 60 min. The mixture was then filtered through a coarse frit, washed two times with 2 mL toluene and three times with 2 mL isohexane, and dried under vacuum for 60 min. Al: 8.1%; Zr: 0.34% (Table 2, Entry 4).

### Example 9

### Aspect One—EAO/Silica/C₆F₅OH/Amine/M2

In the glovebox, 1.0 g EAO coated silica (containing 3.6 mmol Al) from Example 3—ASPECT ONE and 3.0 g toluene were charged to a 20 mL vial and the mixture was mixed well. 0.18 g (0.98 mmol) CO₆F₅OH and 11.0 g toluene were charged to a 4 mL vial. The phenolic alcohol solution was then slowly added to the EAO coated silica slurry. The slurry was then placed on a shaker to shake for 15 min. Then 15 mg PhNMe₂ (0.12 mmol) was added to the reaction mixture, followed by shaking for another 30 min. The mixture was then filtered through a coarse frit, washed two times with 3 g toluene, and dried under vacuum for 2 min. The wet solid was transferred back to the 20 mL vial. 1.9 g toluene and 0.42 g of 5.8% M2 toluene solution (79 μmol Zr) were added to the wet solid, followed by vigorous shaking on a shaker for 60 min. The mixture was then filtered through a coarse frit, washed two times with 4 g toluene and dried under vacuum overnight: giving a 1.28 g yield. Zr: 0.49% (Table 2: Entry 5).

### Example 10

### Aspect One—EAO/Silica/C₆F₅OH/M2

In the glovebox, 10 g EAO coated silica (containing 3.6 mmol Al) from Example 3—ASPECT ONE and 3.0 g toluene were charged to a 20 mL vial and the mixture was mixed well. 0.19 g (1.01 mmol) O₆F₅OH and 10 g toluene were charged to a 4 mL vial. The phenolic alcohol solution was then slowly added to the EAO coated silica slurry. The slurry was then placed on a shaker to shake for 15 min. The mixture was then filtered through a coarse frit washed two times with 5 g isohexane, and dried under vacuum for 3 nm. The wet solid was transferred back to the 20 mL vial. 3.0 g toluene and 0.41 g of 5.8% M2 toluene solution (77 μmol Zr) was added to the wet solid, followed by vigorous shaking on a shaker for 60 min. The mixture was then filtered through a coarse fit, washed two times with 3 g toluene and dried under vacuum overnight, giving a 1.28 g yield. Al: 6.7%; Zr: 0.42% (Table 2, Entry 6).

### Example 11

### Aspect One—EAO/Silica/M1

In the glovebox, 1.0 g EAO coated silica (containing 4.24 mmol Al) from Example 3—ASPECT ONE and 4.0 g toluene were charged to a 20 mL vial and the mixture was mixed well. 17 mg M1 solid (41 μmol) was then added, followed by vigorous shaking on a shaker for 60 min. The mixture was then filtered through a coarse frit, washed two times with 2 mL toluene and three times with 2 mL isohexane, and dried under vacuum for 60 min. Al: 9.80%; Zr: 0.37%. (Table 2, Entry 7).

### Example 12

### Aspect One EAO/Silica/M1

In the glovebox, 1.2 g EAO-m coated silica (containing 4.24 mmol Al) from Example 4—ASPECT ONE and 3.0 g toluene were charged to a 20 mL vial and the mixture was mixed well. 15 mg M1 solid (36 μmol) was then added, followed by vigorous shaking on a shaker for 60 min. The mixture was then filtered through a coarse frit washed three times with 4 g toluene, and dried under vacuum overnight to yield 1.2 g product, (Table 2, Entry 8).

### Polymerization Test

### Example 13

### Aspect One—Polymerization Test

A 4 L reactor was dried by heating at 100 for 15 minutes minimum under low pressure nitrogen flow. After cooling to ambient, the reactor was pressurized with isobutane and vented three times to remove nitrogen. Isobutane (1000 ml) was charged into the reactor while adding 40 ml of dried 1-hexene and 2 ml of 10% TIBA scavenger, such as organoaluminum compound as described herein. The reactor agitator was set at 800 rpm. After flushing the charging line with 700 ml of isobutane, the reactor was charged with ethylene up to 320 psi for supported M1 or 450 psi for supported M2 while at the same time bringing the temperature of the reactor up to 80° C. Then, 50-100 mg of solid catalyst was slurried in 2 ml of hexane in the glovebox and then injected into the reactor followed by 1100 ml of iso butane. The reaction pressure was maintained at 320 psi or 450 psi and the polymerization was carried out for 1 hour at 80° C. The reaction was stopped by venting off the ethylene and isobutane. The polymer was isolated, dried, and weighed. The polymerization activity of each catalyst was calculated and listed in Table 2.

### Evidence of Bronsted Acid Activation

### Example 14

### Aspect One—N—H and O—H Stretching Frequencies in IR Spectra

IR Studies of Bronsted Acid Activators and Catalyst: Spectra were acquired on certain samples according to the following: The solid sample was transferred to a DRIFT-IR cell in the glovebox and the cell was sealed. Then the cell was secured on a Nicolet DRIFT-IR instrument and purged with dried nitrogen for 5 minutes. The spectrum was acquired. The acquired spectra are shown in FIG. 1 and FIG. 2.

Verification of Bronsted Acid Activation Mechanism—Spectrum a in FIG. 1 was obtained from the EAO coated silica (calcined at 600° C.) obtained from Example 3—ASPECT ONE. The OH shown in the IR spectrum was the “hidden” OH groups on the silica. These “hidden” OH groups cannot be accessed by any chemicals referenced in this specification, including the very reactive reagent 2-MeC₆H₄CH₂MgCl used to determine active proton content on silica. Spectra b in FIG. 1 and FIG. 2 were obtained from the EAO/Silica reacted with C₆F₅OH obtained from Example 8(I)—ASPECT ONE; Bronsted acid sites were formed and the OH intensity increased. However, these active OH groups were not stable and the OH peak intensity decreased quickly over time. Spectra c in FIG. 1 and FIG. 2 were obtained from the EAO/Silica reacted with C₆F₅OH and amine of Example 7(I)—ASPECT ONE. The presence of amine in the sample from Example 7—ASPECT ONE stabilized the Bronsted acid sites by proton transfer from OH to amine, thus lowering the OH intensity slightly. Spectra d in FIG. 1 and FIG. 2 were obtained from the sample of Example 7(II)—ASPECT ONE; the OH spectrum d of FIG. 1 is similar to that of spectrum c of FIG. 1 indicating the remaining OH in the sample analyzed for spectrum c were not the active species anymore, i.e., the “hidden” OH.

In the N—H region in IR spectra (FIG. 2), the formation of the N—H stretching peak at 3258 cm⁻¹ in spectrum c (based on a sample from Example 7(I)—ASPECT ONE demonstrated the proton transfer from O—H to N—H. After the active proton of N—H was reacted with metallocene to form Example 7(II)—ASPECT ONE, the intensity of the N—H peak decreased dramatically, indicating that the N—H species was actually the active species (spectrum d of FIG. 2). The amine effect of stabilizing the Bronsted active sites was demonstrated, e.g., when the sample from Example 7(I)—ASPECT ONE was stored at room temperature for two weeks (spectrum e of FIG. 2), the N—H intensity dropped about 50% while the sample from Example 8(I)—ASPECT ONE, which has no amine stabilization, lost most of the active protons. Even after the sample from Example 7(I)—ASPECT ONE was stored at room temperature for two months (spectrum f of FIG. 2), about 25% of NH species still remained. Therefore the IR studies supported the Bronsted acid activation mechanism and that amine stabilized the Bronsted acid sites.

### Example 15

### Aspect One—NMR Analysis Through Grignard Titration for Active Proton Quantification

¹H NMR spectroscopy was used to determine the active proton content in these supported Bronsted acid activators. The supported activators were first treated with excess 2-methylbenzyl magnesium chloride. Based on the reaction that one active proton reacts with one 2-methylbenzylmagnesium chloride to produce one o-xylene (to avoid toluene residue interference), the amount of the produced o-xylene was then quantified by ¹H NMR spectroscopy with normalization to THF solvent to determine the actual active proton content. The instrument used was a Bruker DPX 400 (400 MHz); the reagents used were 2-methylbenzylmagnesium chloride (2-MeC₆H₄CH₂MgCl) in tetrahydrofuran (THF) (Aldrich) (2 M solution was diluted to 0.1 M with Na/K dried THF). To do the calculation, the reagent used was first calibrated to determine the amount of o-xylene originally present in the reagent. Representative results are summarized in Table 3.

TABLE 3
Active Proton Contents in Supported Brønsted Acid Activators

| | | | Active |
|---|---|---|---|
| | AO/Silica | C₆F₅OH/Al | Proton |
| Entry 1 | (Al, mmol/g) | (mol:mol) | (mmol/g) |
| 4 | EAO/ES70 | 0 | 0 |
| | 3.4 | | |
| 2 | EAO/ES70 | 24 | 0.035 |
| | 3.4 | | |
| 3 | EAO/ES70 | 40 | 0.046 |

In this embodiment, C₆F₅OH is charged such that active proton concentration in the activator composition will fall within the Zr loading range to avoid potential loss of both alkyl groups from the Zr if active proton concentration is too high and to avoid loss of activation activity if active proton concentration is too low.

To generate the desired amount of Bronsted acid sites, the charge of C₆F₅OH is based on Al—R residue on the AO coated silica. For example, if the Al—R concentration (titrated with CF₃COOH and quantified with NMR spectroscopy) is high, e.g., the EAO (from 0.9 eq water to Al) coated silica required more C₆F₅OH (Table 2, Entries 3, 4, 5, and 6) to clean the active Al—R species before the active proton can be generated, whereas EAO-m (from 1.0 eq water to Al) coated silica required significantly less to do the same (Table 2, Entries 1 and 2).

Zr-Me Ratio: Methane was released during the activation and detected by NMR spectroscopy. To verify the Bronsted acid activator as the major activator in the system, CF₃COOH was used to titrate the supported catalyst to determine the Zr:Me ratio. The results are listed in Table 4.

TABLE 4
Quantification of Zr-Me Species in Supported M1 Catalyst

| | | | Time of | |
|---|---|---|---|---|
| | | | C₆F₅OH | |
| | | C₆F₅OH:Al | Treatment | Me-Zr:Zr |
| Entry | Activator | (mol:mol) | (min) | (mol:mol) |
| 1 | C₆F₅OH/EAO-m/Grace952 | 25:100 | 120 | 87:100 |
| 2 | C₆F₅OH/EAO/Grace952 | 29:100 | 15 | 33:100 |

The Me:Zr ratios smaller than 1 indicate the Bronsted acid activation mechanism. Table 4 Entry 1 indicates a near match of the active proton and the metallocene, whereas Entry 2 indicates over activation (66% LZrMe₂ lost both of the methyl groups). The active proton concentration is too high because of a higher C₆F₅OH charge and significantly shorter reaction time.

### —Aspect Three

### Example 1

### Aspect Three Preparation of Ethylaluminoxane (EAO)

A 1-L jacketed reactor was equipped with an overhead stirrer a thermocouple, a nitrogen purge, and a gas outlet. A toluene solution of triethylaluminum (TEA) was prepared in an aluminum alkyl container from 114.4 g of TEA and 348.2 g of toluene and this solution (462.6 g) was charged to the nitrogen-purged jacketed reactor. The agitation speed of stirrer was set at 400 rpm and the cooling fluid in reactor jacket was set to −20° C. The TEA reaction solution was cooled to −20° C. before water addition. A syringe pump was used to feed deionized H₂O (16.3 g) into the reactor slowly, corresponding to a molar ratio of water to TEA of about 0.9:1. The temperature of reaction solution was maintained from about −7° C. to about −20° C. throughout the course of the hydrolysis reaction. After the water addition was complete, the reactor was allowed to warm slowly to room temperature (about 25° C.) and was maintained at about 25° C. for 1 h. After this time, the clear ethylaluminoxane toluene solution was decanted from any solid that may have formed and transferred into a nitrogen-purged glovebox for further use. The typical Al content in the final product was about 5.68 wt %.

### Example 2

### Aspect Three Preparation of Modified Ethylaluminoxane (EAO-m)

An aluminoxane solution was prepared from a mixture of about 90 mol % triethylaluminum (TEA) and about 10 mol % triisobutylaluminum (TIBA) using a procedure analogous to that described in Example 1—ASPECT THREE. This aluminoxane prepared from a combination of aluminoxanes that comprise a majority of TEA is referred to herein as a “modified” ethylaluminoxane or “EAO-m,” which can also be referred to as “ethyl-isobutylaluminoxane.” In this example, TEA (99.3 g) and TIBA (19.2 g) were mixed with toluene (347.6 g) to form a solution containing about 90 mol % TEA and about 10 mol % TIBA. Deionized H₂O (17.4 g) was fed slowly into the reactor and the reaction was carried out and worked-up by a procedure analogous to that described in Example 1—ASPECT THREE. The molar ratio of water to alkyl aluminum (TEA and TIBA combined) employed was about 1:1. The typical Al content in the final product was about 5.66 wt %.

### Example 3

### Aspect Three Preparation of an EAO-Coated Silica

A silica having a BET surface area (multiple point) of about 300 m²/g and a pore volume of about 1.5 mL/g was calcined at 600° C. for about 4 h, after which time the hot silica was allowed to cool while being placed under vacuum, then transferred into nitrogen-purged glovebox. In the glovebox, about 20.0 g of the calcined silica was added to a flask along with about 80 g of dry toluene. While this slurry was stirred, 60 g of an EAO-toluene solution containing about 3.41 g of Al, based on the 5.68% Al concentration of in the solution, was slowly added to the slurry. This mixture was then heated to about 100° C. and maintained at this temperature for about 3 hr. The stirring was stopped and the mixture was allowed to cool to ambient temperature over about 2 hr, after which time the mixture was filtered through a coarse frit and the product was washed three times with 30 mL of isohexane and dried under vacuum overnight. This procedure afforded about 26.9 g of product (Al content, 9.05 wt %).

### Example 4

### Aspect Three Preparation of an EAO-m-Coated Silica

The silica used in Example 3—ASPECT THREE was calcined and transferred to a drybox as described in Example 3. In the glovebox, about 20.0 g of the 600° C.-calcined silica was added to a flask along with about 80 g of dry toluene. While this slurry was stirred, 70 g of an EAO-m-toluene solution containing about 3.96 g of Al, based on the 5.66% Al concentration of in the solution, was slowly added to the slurry. This mixture was then heated to about 100° C. and maintained at this temperature for about 3 hr. The stirring was stopped and the mixture was allowed to cool to ambient temperature over about 40 min, after which time the mixture was filtered through a coarse frit, and the product was washed three times with 30 mL of isohexane and dried under vacuum for about 90 min. This procedure afforded about 33.2 g of product (Al content, 11.45 wt %).

### Example 5

### Aspect Three Supported Catalyst without an Optional Amine: Preparation of 2,6-Me₂PhOH/EAO-m/Silica/M6

In a glovebox, a 20 mL vial was charged with 1.0 g of EAO-m-coated silica containing 4.24 mmol of Al and 3.0 g of toluene, and the resulting slurry was stirred. A solution of 0.20 g of 2,6-Me₂PhOH (1.6 mmol) in 1 g of toluene was prepared in another vial, and this substituted phenol solution was added slowly to the EAO-m-coated silica slurry with stirring. When the addition was completed, the resulting mixture was placed on a shaker to shake for 60 min. The mixture was then filtered through a coarse frit, and the resulting solid was washed twice with 3 g of toluene and dried under vacuum for about 30 seconds. This solid was then transferred back into the 20 mL vial, and toluene (3.0) and solid Mg (17 mg, 41 μmol) were added to the vial, after which the vial was placed on a shaker to vigorously shake for 60 min. This mixture was then filtered through a coarse frit and the resulting solid was washed twice with 3 g of toluene, and dried under vacuum for 30 min, to afford 1.30 g of the catalyst. Analysis (wt %): Al: 9.00%; Zr: 0.16%. See: Table 5, Entry 2.

### Example 6

### Aspect Three Supported Catalyst without an Optional Amine: Preparation of 2,6-i-Pr₂PhOH/EAO-m/Silica/M6

In a glovebox, a 20 mL vial was charged with 1.0 g of EAO-m-coated silica containing 4.24 mmol of Al and 4.0 g of toluene, and the resulting slurry was stirred. A solution of 0.22 g 2,6i-Pr₂PhOH (1.6 mmol) in 2 g of toluene was prepared in another vial, and this substituted phenol solution was added slowly to the EAO-m-coated silica slurry with stirring. When the addition was completed, the resulting mixture was placed on a shaker to shake overnight. The mixture was then filtered through a coarse frit, and the resulting solid was washed three times with 2 mL of isohexane and dried under vacuum for about 30 min. This solid was then transferred back into the 20 mL vial, and toluene (4.0 g) and solid rac-dimethylsilylbis(4,5,6,7-tetrahydroindenyl)zirconium dimethyl (M6) (17 mg, 41 mol) were added to the vial, after which the vial was placed on a shaker to vigorously shake for 60 min. This mixture was then filtered through a coarse frit, and the resulting solid was washed twice with 2 mL of toluene, then 3×2 mL of isohexane, and dried under vacuum for 60 min, to afford the catalyst. Analysis (wt %): Al: 11.8%; Zr; 0.14%. See: Table 5, Entry 3.

### Example 7

### Aspect Three Supported Catalyst without an Optional Amine: Preparation of 2,6-t-Bu₂-4-MePhOH/EAO-m/Silica/M6

In a glovebox, a 20 mL vial was charged with 1.0 g of EAO-m-coated silica containing 4.24 mmol of Al and 3.0 g of toluene, and the resulting slurry was stirred. A solution of 0.26 g of 2,6-t-Bu₂-4-MePhOH (1.2 mmol) in 1 g of toluene was prepared in another vial, and this substituted phenol solution was added slowly to the EAO-m-coated silica slurry with stirring. When the addition was completed, the resulting mixture was placed on a shaker to shake for 60 min. The mixture was then filtered through a coarse frit, and the resulting solid was washed twice with 3 g of toluene and dried under vacuum for about 30 seconds. This solid was then transferred back into the 20 mL vial, and toluene (3.0 g) and solid rac-dimethylsilylbis(4,5,6,7-tetrahydroindenyl)zirconium dimethyl (M6) (18 mg, 43 μmol) were added to the vial, after which the vial was placed on a shaker to vigorously shake for 60 min. This mixture was then filtered through a coarse frit, and the resulting solid was washed twice with 3 g of toluene, and dried under vacuum overnight, to afford 1.08 g of the catalyst. Analysis (wt %): Al: 11.43%; Zr: 0.33%. See: Table 5, Entry 4.

### Example 8

### Aspect Three Supported Catalyst without an Optional Amine: Preparation of 2-t-Bu-6-MePhOH/EAO/Silica/M6

In a glovebox, a 20 mL vial was charged with 1.0 g of EAO-coated silica containing 4.24 mmol of Al and 3.0 g of toluene, and the resulting slurry was stirred. A solution of 0.18 g 2-t-Bu-6-MePhOH (0.87 mmol) in 1 g of toluene was prepared in another vial, and this substituted phenol solution was added slowly to the EAO-coated silica slurry with stirring. When the addition was completed, the resulting mixture was placed on a shaker to shake for 60 min. The mixture was then filtered through a coarse frit and the resulting solid was washed twice with 3 g of toluene and dried under vacuum for about 30 seconds. This solid was then transferred back into the 20 mL vial, and toluene (3.0 g) and solid rac-dimethylsilylbis(4,5,6,7-tetrahydroindenyl)zirconium dimethyl (M6) (15 mg, 36 mol) were added to the vial, after which the vial was placed on a shaker to vigorously shake for 60 min. This mixture was then filtered through a coarse fit, and the resulting solid was washed two times with 3 g of toluene once with 3 g of isohexane, and dried under vacuum for 30 min, to afford 1.03 g of the catalyst. Analysis (wt %): Al: 6.7%; Zr: 0.13%. See: Table 5, Entry 5.

### Example 9

### Aspect Three Supported Catalyst without an Optional Amine: Preparation of 2-PhPhOH/EAO/Silica/M6

In a glovebox, a 20 mL vial was charged with 0.40 g of EAO-coated silica containing 4.24 mmol of Al and 2.0 g of toluene, and the resulting slurry was stirred. A solution of 0.04 g of 2-PhPhOH (0.247 mmol) and 0.5 g of toluene was prepared in another vial, and this substituted phenol solution was added slowly to the EAO-coated silica slurry with stirring. When the addition was completed, the resulting mixture was placed on a shaker to shake for 3 min. The mixture was then filtered through a coarse frit, and the resulting solid was washed once with 5 mL of isohexane and dried under vacuum for about 1 min. This solid was then transferred back into the 20 mL vial, and toluene (2.0 g) and solid rac-dimethylsilylbis(4,5,6,7-tetrahydroindenyl)zirconium dimethyl (M6) (11 mg, 26 μmol) were added to the vial, after which the vial was placed on a shaker to vigorously shake for about 15 min. This mixture was then filtered through a coarse frit, and the resulting solid was washed twice with 6 mL of isohexane, and dried under vacuum for 30 min, to afford 1.05 g of the catalyst. See: Table 5, Entry 6.

### Example 10

### Aspect Three Supported Catalyst without an Optional Amine: Preparation of 2-t-BuPhOH/EAO-m/Silica/M6

In a glovebox, a 20 mL vial was charged with 1.0 g of EAO-m-coated silica containing 4.24 mmol of Al and 3.0 g of toluene, and the resulting slurry was stirred. A solution of 0.20 g of 2-t-BuPhOH (1.33 mmol) and 1 g of toluene was prepared in another vial, and this substituted phenol solution was added slowly to the EAO-m-coated silica slurry with stirring. When the addition was completed, the resulting mixture was placed on a shaker to shake for 60 min. The mixture was then filtered through a coarse frit, and the resulting solid was washed twice with 3 g of toluene and dried under vacuum for about 30 seconds. This solid was then transferred back into the 20 mL vial, and toluene (3.0 g) and solid rac-dimethylsilylbis(4,5,6,7-tetrahydroindenyl)zirconium dimethyl (M6) (19 mg, 46 μmol) were added to the vial, after which the vial was placed on a shaker to vigorously shake for 60 min. This mixture was then filtered through a coarse frit, and the resulting solid was washed twice with 3 g of toluene, and dried under vacuum for 60 min, to afford 1.04 g of the catalyst. Analysis (wt %): Al: 10.3%; Zr: 0.28%. See, Table 5, Entry 7.

### Example 11

### Aspect Three Supported Catalysts without a Substituted Phenol and without an Optional Amine: Preparation of EAO/Silica/M6

In a glovebox, a 20 mL vial was charged with 1.0 g of EAO-coated silica containing 4.24 mmol of Al and 4.0 g of toluene, and the resulting slurry was stirred. Solid rac-dimethylsilylbis(4,5,6,7-tetrahydroindenyl)zirconium dimethyl (M6) (17 mg, 41 μmol) was then added to the stirred mixture, after which the vial was placed on a shaker to vigorously shake for 60 min. This mixture was then filtered through a coarse frit, and the resulting solid was washed two times with 2 mL of toluene followed by three times with 2 mL of isohexane, and dried under vacuum for 60 min to afford the catalyst. Analysis (wt %): Al: 9.80%; Zr: 0.37%. See: Table 5, Entry 8.

### Example 12

### Aspect Three Supported Catalysts without a Substituted Phenol and without an Optional Amine: Preparation of EAO-m/Silica/M6

In a glovebox, a 20 mL vial was charged with 1.2 g of EAO-m-coated silica containing 4.24 mmol of Al and 3.0 g of toluene, and the resulting slurry was stirred. Solid rac-dimethylsilylbis(4,5,6,7-tetrahydroindenyl)zirconium dimethyl (M6) (15 mg, 36 mmol) was then added to the stirred mixture, after which the vial was placed on a shaker to vigorously shake for 60 min. This mixture was then filtered through a coarse frit, and the resulting solid was washed three times with 4 g of toluene, and dried under vacuum overnight to afford 1.2 g of the catalyst. See: Table 5, Entry 9.

### Example 13

### Aspect Three Supported Catalysts with an Optional Amine Added Along with the Substituted Phenol Preparation of 2,6-Me₂PhOH/EAO/Silica/PhNMe₂/M6

In a glovebox, a 20 mL vial was charged with 1.0 g of EAO-coated silica containing 3.35 mmol of Al and 3.0 g of toluene, and the resulting slurry was stirred. A solution of 0.20 g of 2,6-Me₂PhOH (1.6 mmol) and 1 g of toluene was prepared in another vial, and this substituted phenol solution was added slowly to the EAO-coated silica slurry with stirring, immediately followed by the addition of 0.06 g (0.49 mmol) of PhNMe₂ to the stirred slurry. When the addition was completed, the resulting mixture was placed on a shaker to shake for 60 min. The mixture was then filtered through a coarse frit, and the resulting solid was washed twice with 5 g of isohexane and dried under vacuum for about 10 min. This solid was then transferred back into the 20 mL vial, and toluene (4.0 g) and solid rac-dimethylsilylbis(4,5,6,7-tetrahydroindenyl)zirconium dimethyl (M6) (20 mg, 48 μmol) were added to the vial, after which the vial was placed on a shaker to vigorously shake for 60 nm. This mixture was then filtered through a coarse frit, and the resulting solid was washed twice with 5 g of isohexane, and dried under vacuum for 45 min, to afford 1.23 g of the catalyst. Analysis (wt %): Al: 6.95%; Zr: 0.27%. See, Table 5, Entry 1 and Table 6, Entry 1.

### Example 14

### Aspect Three Supported Catalysts with an Optional Amine Added after Treatment with a Substituted Phenol: Preparation of 2,6-Me₂PhOH/EAO-m Silica/PhNMe₂-7

In a glovebox, a 20 mL vial was charged with 1.0 of EAO-coated silica containing 4.24 mmol of Al and 3.0 g of toluene, and the resulting slurry was stirred. A solution of 0.20 g of 2,6-Me₂PhOH (1.6 mmol) and 1 g of toluene was prepared in another vial, and this substituted phenol solution was added slowly to the EAO-coated silica slurry with stirring. When the addition was completed, the resulting mixture was placed on a shaker to shake for about 10 min. After this time, 0.060 g of PhNMe₂ (0.5 mmol) was added to the mixture, which was then placed on a shaker to vigorously shake for about 50 min. The mixture was then filtered through a coarse frit, and the resulting solid was washed twice with 3 g of toluene and dried under vacuum for about 30 seconds. This solid was then transferred back into the 20 mL vial, and toluene (3.0 g) and a toluene solution containing 5.8% bis(1,3-dimethylcyclopentadienyl)zirconium dimethyl (M7) (0.40 g, 75 μmol of M7) were added to the vial, after which the vial was placed on a shaker to vigorously shake for 60 min. This mixture was then filtered through a coarse fit, and the resulting solid was washed twice with 3 g of toluene, and dried under vacuum for 60 min, to afford 1.06 g of the catalyst. Analysis (wt %): Al: 10.48%; Zr: 0.45%. See: Table 6, Entry 2.

### Example 15

### Aspect Three Supported Catalysts with an Optional Amine Added after Treatment with a Substituted Phenol: Preparation of 2-PhPhOH/EAO-m/Silica/PhNMe₂/M7

In a glovebox, a 20 mL vial was charged with 1.0 g of EAO-coated silica containing 4.24 mmol of Al and 3.0 g of toluene, and the resulting slurry was stirred. A solution of 0.21 g of 2-PhPhOH (1.24 mmol) and 1 g of toluene was prepared in another vial, and this substituted phenol solution was added slowly to the EAO-coated silica slurry with stirring. When the addition was completed, the resulting mixture was stirred at ambient temperature for about 15 min, then at 70° C. for about 60 min. After this time, the mixture was cooled to ambient temperature, and 4 mg of PhNMe₂ (0.03 mmol) was added to the mixture, which was then placed on a shaker to shake for about 60 min. The mixture was then filtered through a coarse frit, and the resulting solid was washed twice with 6 g of isohexane and dried under vacuum for about 30 seconds. This solid was then transferred back into the 20 mL vial, and toluene (3.0 g) and a toluene solution containing 5.8% bis(1,3-dimethylcyclopentadienyl)zirconium dimethyl (M7) (0.40 g, 75 μmol of M7) were added to the vial, after which the vial was placed on a shaker to vigorously shake for 60 min. This mixture was then filtered through a coarse frit, and the resulting solid was washed twice with 6 g of isohexane, and dried under vacuum for 60 min, to afford 1.25 g of the catalyst. Analysis (wt %): Al: 9.42%; Zr: 0.29%. See: Table 6, Entry 3.

### Example 16

### Aspect Three Polymerization Tests

A dried, 4-L reactor was heated to 80° C. under a low-pressure nitrogen flow. Once this temperature was attained, the reactor was pressured with isobutene and vented three times to remove the nitrogen. Afterwards, 1000 mL of isobutane was charged into the reactor and the reactor agitator was stirred at 800 rpm. After the temperature stabilized to 80° C., ethylene was charged into the reactor up to a pressure of 320 psi, after which 40 mL of dried 1-hexene was added, followed by 500 mL of isobutene. Next, 2 mL of 10% TIBA hexane solution was added as scavenger agent. A slurry of about 50 mg to about 100 mg of solid catalyst in 2 mL of hexane was then injected in to reactor, followed by another 500 mL of isobutene. The reaction pressure was maintained at 320 psi of ethylene and the polymerization reaction was conducted for 60 minutes at 80° C. After this time, the reaction was quenched by stopping the ethylene feeding and venting the volatiles. The resulting polymer was collected, dried, and weighed. The polymerization activity of each catalyst was calculated and data are provided in the following tabes

TABLE 5
POLYMERIZATION DATA FOR SUPPORTED METALLOCENE CATALYSTS
DERIVED FROM VARIOUS SUBSTITUTED PHENOLS ^{A}

| | | PHNME₂ | | PRODUC- | |
|---|---|---|---|---|---|
| | ROH/ALUMINOXANE | CHARGE | | TIVITY | ACTIVITY |
| | AND MOLAR RATIO | (MOL % ON | | (G/G | (KG/MOL |
| ENTRY | (MOL:MOL/OH:AL) | Al) | ZR % | CAT/HR) | ZR/HR) |
| 1 | 2,6-ME₂PHOH/EAO | 15 | 0.27 | 2,000 | 67,600 |
| | 0.48:1 | | | | |
| 2 | 2,6-ME₂PHOH/EAO-M | 0 | 0.16 | 130 | 7,400 |
| | 0.38:1 | | | | |
| 3 | 2,6-IPR₂PHOH/EAO-M | 0 | 0.14 | 515 | 36,100 |
| | 0.25:1 | | | | |
| 4 | 2,6-^{T}BU₂-4- | 0 | 0.33 | 625 | 17,300 |
| | MEPHOH/EAO-M | | | | |
| | 0.28:1 | | | | |
| 5 | 2-^{T}BU-6-MEPHOH/EAO | 0 | 0.13 | 650 | 45,600 |
| | 0.26:1 | | | | |
| 6 | 2-PHPHOH/EAO | 0 | 0.50 ^{B} | 680 | 12,400 |
| | 0.18:1 | | | | |
| 7 | 2-^{T}BUPHOH/EAO-M | 0 | 0.28 | 1,070 | 34,900 |
| | 0.31:1 | | | | |
| a | NONE/EAO | 0 | 0.37 | 400 | 9,900 |
| | 0:1 | | | | |
| 9 | NONE/EAO-M | 0 | 0.30 ^{B} | 262 | 8,000 |
| | 0:1 | | | | |

^{A} The metallocene employed in each test was rac-dimethylsilylbis(4,5,6,7- tetrahydroindenyl)zirconium dimethyl (M6).
^{B} BASED ON THE ZR CHARGE.

TABLE 6
POLYMERIZATION DATA FOR SUPPORTED METALLOCENE
CATALYSTS DERIVED FROM VARIOUS SUBSTITUTED
PHENOLS AND VARIOUS METALLOCENES

| | | | | PRODUC- | |
|---|---|---|---|---|---|
| | | | | TIVITY | ACTIVITY |
| | | AL | ZR | (G/G | (KG/MOL |
| ENTRY | CATALYST SYSTEM ^{A} | % | % | CAT/HR) | ZR/HR) |
| 1 | M6 AND | 6.95 | 0.26 | 2,000 | 70,132 |
| | 2.6- | | | | |
| | ME₂PHOH/EAO/SIO₂/PHNME₂ | | | | |
| 2 | M7 AND | 10.48 | 0.45 | 350 | 7,100 |
| | 2,6-ME₂PHOH/EAO- | | | | |
| | M/SIO₂/PHNME₂ | | | | |
| 3 | M7 AND | 9.42 | 0.29 | 500 | 15,700 |
| | 2-PHPHOH/EAO- | | | | |
| | M/SIO₂/PHNME₂ | | | | |

^{A} THE METALLOCENE EMPLOYED WAS EITHER RAC-DIMETHYLSILYLBIS(4,5,6,7-TETRAHYDROINDENYL)ZIRCONIUM DIMETHYL (M6) OR BIS(1,3-DIMETHYLCYCLOPENTADIENYL)ZIRCONIUM DIMETHYL (M7).

The results of Table 5 indicate that generally for the same metallocene catalyst, better catalyst activities were obtained when the aluminoxane-treated inorganic oxide is treated with a substituted electron-donating phenol as defined herein. The results of Table 6 indicate that activity is observed for both bridged and for unbridged metallocene catalysts, though higher activities appeared to arise from the bridged metallocene catalysts.

### —Aspect Four

TABLE 7
Ethylene Polymerization Performance of Supported Catalysts from Different Recipes

| | Catalyst | | C₆F₅OH | Me₂PhOH | PhNMe₂ | | | Productivity | Activity |
|---|---|---|---|---|---|---|---|---|---|
| Entry | Precursor | Method¹ | (mol %)² | (mol %)² | (mol %)² | Al % | Zr % | (g/g cat/hr) | (kg/mol Zr/hr) |
| 1 | M5 | III | 9.5 | 49 | 9.5 | 8.43 | 0.50 | 4,800 | 87,600 |
| 2 | M8 | II | 13 | 39 | 12 | 9.32 | 0.42 | 4,000 | 86,900 |
| 3 | M7 | II | 12 | 37 | 12 | 8.44 | 0.41 | 3,600 | 80,100 |
| 4 | M6 | I | 1.5 | 24 | 1.5 | — | 0.32* | 1,025 | 29,200 |
| 5 | M7 | I | 1.5 | 24 | 1.5 | — | 0.27* | 350 | 11,800 |
| 6 | M6 | N/A | 0 | 49 | 15 | 6.95 | 0.27 | 2,000 | 67,600 |
| 7 | M6 | N/A | 0 | 39 | 0 | 9.00 | 0.16 | 130 | 7,400 |
| 8 | M6 | N/A | 22 | 0 | 0 | 10.23 | 0.27 | 2,000 | 67,600 |
| 9 | M6 | N/A | 23 | 0 | 12 | 10.07 | 0.40 | 4,000 | 91,200 |
| 10 | M6 | N/A | 0 | 0 | 0 | 11.45 | 0.30* | 262 | 8,000 |

¹Method I: add electron donating (C′) first, then the mixture of electron
withdrawing (C) and amine (E); Method II: add the mixture of electron
donating (C′) and amine (E), then add electron withdrawing (C); Method III: add
electron withdrawing phenol (C) first, then electron donating phenol (C′), then amine (E).
²based on Al
*Zr charge
M6: rac-dimethylsilylbis(4,5,6,7-tetrahydroindenyl)zirconium dimethyl

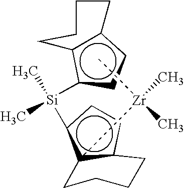

M7: bis(1,3-dimethylcyclopentadienyl)zirconium dimethyl

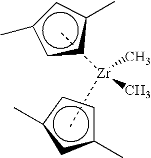

M8: 1-(9-fluorenyl)-1-(cyclopentadienyl)-1-(methyl)-1-(but-3-enyl)methane zirconium
dimethyl

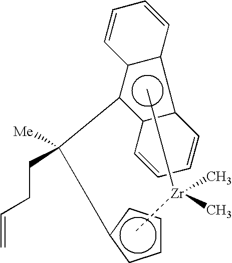

M5: Ethylenebis(indenyl)zirconium dimethyl

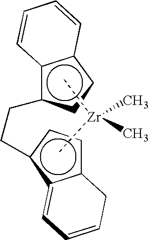

### Aluminoxanes

### Example 1

### Aspect Four—EAO

A 1 L jacketed reactor was equipped with overhead stirrer, thermocouple, nitrogen pure and gas outlet. Triethylaluminum (TEA) 114.4 g was mixed with toluene 348.2 g to form a solution in an aluminum alkyl container and 462.6 g of this solution was charged in the nitrogen-purged jacketed reactor. The agitation speed of stirrer was set at 400 rpm. The cooling fluid in reactor jacket was set to 2000 and the reaction solution was cooled to −20° C. before water addition. Syringe pump was used to feed deionized H₂O (16.3 g) into the reactor slowly. The temperature of reaction solution was maintained between −7 to −20° C. The reactor was warmed back to 25° C. slowly after water feeding and kept at 25° C. for 1 h. The reaction was finished and the top layer of clear solution was decanted into a dried bottle. The bottle of ethylaluminoxane solution was brought into nitrogen-purged glovebox for further use. The typical Al content in the final product was 5.68%.

### Example 2

### Aspect Four—EAO-m (Modified Ethylaluminoxane)

The same equipment and procedure were used as in Example 1—ASPECT FOUR to prepare EAO-m. TEA 99.3 g and triisobutylaluminum (TIBA) 19.2 g were mixed with toluene (347.6 g) to form a solution containing about 90 mol % TEA and 10 mot % TIBA. Deionized H₂O (17.4 g) was fed into the reactor slowly. The typical Al content in the final product was 5.66%.

### Aluminoxane Coated Silica

### Example 3

### Aspect Four—EAO Coated Silica

The silica used in the preparation was Grace 952 (manufactured by W. R. Grace & Co.). The silica was calcined in an oven at 600° C. for 4 h and the hot silica was placed under vacuum before transferring into the glovebox.

In the glovebox, 20.0 g of the 600° C.-calcined silica was placed in a flask with 80 g dry toluene. Then a solution of EAO in toluene 60 g (3.41 g Al, based on about 11% Al in the final product) was slowly added to the silica under stirring. The slurry was then heated to 100° C. and maintained at 100° C. for 3 hr. The string was stopped and the mixture was cooled at ambient temperature for 2 hr. The mixture was then filtered through a coarse frit, washed three times with 30 ml isohexane, and dried under vacuum overnight. 26.9 g of product was obtained (Al=9.05 wt %).

### Example 4

### Aspect Four—EAO-m Coated Silica I

The silica used in the preparation was Grace 952 (manufactured by W. R. Grace & Co.). The silica was calcined in an oven at 600° C. for 4 h and the hot silica was placed under vacuum before transferring into the glovebox.

In the glovebox, 20.0 g of the 600° C.-calcined silica was placed in a flask with 80 g dry toluene. Then a solution of EAO-m in toluene 70 g (3.96 g Al, based on about 13% Al in the final product) was slowly added to the silica under stirring. The slurry was then heated to 100° C. and maintained at 100° C. for 3 hr. The stirring was stopped and the mixture was cooled at ambient temperature for 40 min. The mixture was then filtered through a coarse frit, washed three times with 30 ml isohexane, and dried under vacuum for 90 min. 33.2 g of product was obtained (Al=11.45 wt %).

### Example 5

### Aspect Four—EAO-m Coated Silica III

The silica used in the preparation was Grace 948 (manufactured by W. R. Grace & Co.). The silica was calcined in an oven at 150° C. for 4 h and the hot silica was placed under vacuum before transferring into the glovebox.

In the glovebox, 20.0 g of the 150° C.-calcined silica was placed in a flask with 80 g dry toluene. Then a solution of EAO-m in toluene 70 g (3.96 g Al, based on about 13% Al in the final product) was slowly added to the silica under stirring. The slurry was then heated to 100° C. and maintained at 100° C. for 3 hr. The stirring was stopped and the mixture was cooled at ambient temperature overnight. The mixture was then filtered through a coarse frit washed three times with 20 ml isohexane, and dried under vacuum for 5 hours. 30.2 g of product was obtained (Al=12.45 wt %).

### Supported Catalyst

### Example 6

### Aspect Four—C₆F₅OH/2,6-Me₂PhOH/EAO-m/Silica I/Amine/M5 from Method III (Table 7)

The supported catalyst can be prepared through different addition sequences of electron-donating phenol, electron-withdrawing phenol, and amine. This preparation was based on the following reagent addition sequence: adding electron-withdrawing phenol first then electron-donating phenol, and, finally, amine.

In the glovebox, to a 20 mL vial were charged 1.0 g EAO-m coated silica I (containing 4.24 mmol Al) from Example 4 ASPECT FOUR and 3.5 g toluene and the mixture was mixed well. 74 mg C₆F₅OH (0.402 mmol) and 1.0 g toluene were charged to a 4 mL vial. The phenolic alcohol solution was then slowly added to the EAO-m coated silica slurry. The slurry was then placed on a shaker to shake for 15 min. Then 0.15 g 2,6-Me₂PhOH (1.23 mmol) was added to the mixture. The mixture was then shaken for 30 min in a 70° C. oil bath. PhNMe₂ 0.0509 (0.41 mmol) was added to the hot mixture, followed by shaking for 15 min without heating. The mixture was then filtered through a coarse frit, washed two times with 3 g toluene, and dried under vacuum for 30 seconds. The wet solid was transferred back to the 20 mL vial, 3.0 g toluene and 22 mg M5 solid (58 μmol) were added to the wet solid, followed by vigorous shaking on a shaker for 60 min. The mixture was then filtered through a coarse frit washed two times with 3 g toluene, and dried under vacuum for 30 min, giving a 1.23 g yield. Al: 8.43%; Zr: 0.50% (Table 7, Entry 1).

### Example 7

### Aspect Four—C₆F₅OH/2,6-Me₂PhOH/EAO-m/Silica I/Amine/M8 from Method II (Table 7)

This preparation was based on the reagent addition sequence of electron-donating phenol, amine, and then electron withdrawing phenol shown in Reaction EX 7:

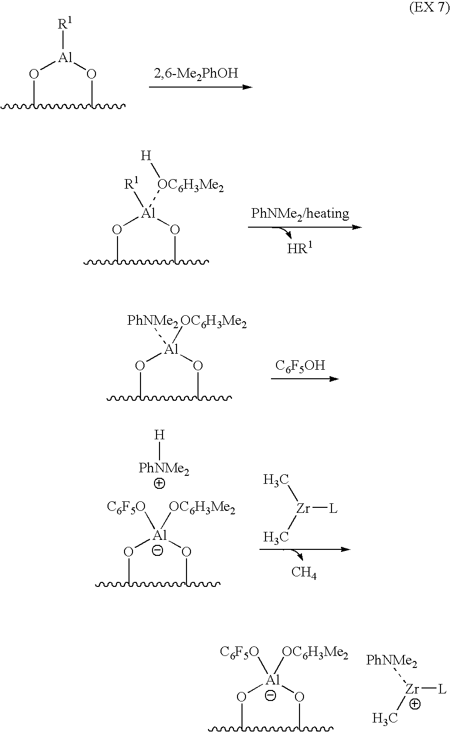

In the glovebox, 1.0 g EAO-m coated silica I (containing 4.24 mmol Al) from Example 4—ASPECT FOUR and 3.0 g toluene were charged to a 20 mL vial and the mixture was mixed well. 0.20 g 2,6-Me₂PhOH (1.64 mmol) and 11.0 g toluene were charged to a 4 mL vial. The phenolic alcohol solution was then added to the EAO-m coated silica slurry. The mixture was then placed on a shaker to shake for 10 min, then placed in a 70° C. oil bath for 15 min. PhNMe₂ 0.060 g (0.495 mmol) was added to the mixture and heating continued at 70° C. for 20 min. The mixture was then cooled to ambient temperature and C₆F₅OH 0.10 g (0.54 mmol) was added, followed by shaking for 30 min. The mixture was then filtered through a coarse frit washed two times with 3 g toluene, and dried under vacuum for 30 seconds. The wet solid was transferred back to the 20 mL vial. 3.0 g toluene and 20 mg M8 solid (58 μmol) were added to the wet solid, followed by vigorous shaking on a shaker for 60 min. The mixture was then filtered through a coarse frit, washed two times with 3 g toluene, and dried under vacuum for 60 min, giving a 1.04 g yield. Al: 9.32%; Zr: 0.42% (Table 7, Entry 2).

### Example 8

### Aspect Four—C₆F₅OH/2,6-Me₂PhOH/EAO-m/Silica I/Amine/M7 from Method II (Table 7)

This preparation used the same reagent addition sequence as in Example 7—ASPECT FOUR, but with a slight modification.

In the glovebox, 1.0 g EAO-m coated silica I (containing 4.24 mmol Al) from Example 4—ASPECT FOUR and 3.0 g toluene were charged to a 20 mL vial and the mixture was mixed well. 0.19 g 2,6-Me₂PhOH (1.55 mmol) and 1.0 g toluene were charged to a 4 mL vial. The phenolic alcohol solution was then added to the EAO-m coated silica slurry. PhNMe₂ 0.064 g (0.53 mmol) was also added to the mixture. The mixture was mixed well and placed in a 70° C. oil bath for 20 min. The mixture was then filtered through a coarse frit, washed two times with 3 g toluene, and dried under vacuum for 30 seconds. The wet solid was transferred back to the 20 mL vial. 94 mg C₆F₅OH (0.51 mmol) in 3 g toluene were added to the wet solid, followed by shaking for 30 min. The mixture was then filtered through a coarse frit, washed two times with 3 g toluene, and dried under vacuum for 30 seconds. The wet solid was transferred back to the 20 mL vial. 3.0 g toluene and 0.30 g 5.8% M2 toluene solution (57 μmol) were added to the wet solid, followed by vigorous shaking on a shaker for 60 min. The mixture was then filtered through a coarse frit, washed two times with 3 g toluene and once with 3 g isohexane, and dried under vacuum for 30 min, giving a 1.03 g yield. Al: 8.4%; Zr: 0.41% (Table 7, Entry 3).

### Example 9

### Aspect Four—C₆F₅OH/2,6-Me₂PhOH/EAO-m/Silica III/Amine/M6 from Method I (Table 7)

The reagent addition sequence for this preparation was first 2,6-Me₂PhOH and then C₆F₅OH and amine together.

In the glovebox, 3.0 g toluene and 2.15 g EAO-m coated silica III (containing 9.91 mmol Al) from Example 5—ASPECT FOUR were charged to a 20 mL vial and the mixture was mixed well. Then 0.293 g solid 2,6-Me₂PhOH (2.40 mmol) was added to the mixture. The mixture was mixed well and placed in a 70° C. oil bath for 90 min. To the mixture was then added the mixture of 27.6 mg C₆F₅OH (0.15 mmol) and 18.2 mg PhNMe₂ (0.15 mmol) in 1 g toluene. After shaking for 16 hours, the mixture was filtered through a coarse frit, washed with 5 g isohexane, and dried under vacuum for 15 seconds. The wet solid was divided as two equal portions in two 20 mL vials, respectively. To one portion, 3.5 g toluene and 15.3 mg M6 (36.8 μmol) were added, followed by shaking for 180 nm. The other portion was used in Example 10—ASPECT FOUR. The mixture was then filtered through a coarse frit, washed two times with 3 g toluene, and dried under vacuum for 60 min, giving a 1.23 g yield (Table 7, Entry 4).

### Example 10

### Aspect Four—C₆F₅OH/2,6-Me₂PhOH/EAO-m/Silica III/Amine/M7 from Method I (Table 7)

The reagent addition sequence for this preparation was first 2,6-Me₂PhOH and then C₆F₅OH and amine together.

3.0 g toluene and 0.26 g 5.8% M7 toluene solution (49.0 μmol) were added to the other portion of phenol/amine treated EAO-m coated silica III from Example 9—ASPECT FOUR, and the mixture was shaken for 180 min. The mixture was then filtered through a coarse fit, washed two times with 3 g toluene, and dried under vacuum for 60 min, giving a 1.36 g yield (Table 71, Entry 5).

### Example 11

### Aspect Four—2,6-Me₂PhOH/EAO/Silica I/Amine/M6

This preparation used only 2,6-Me₂PhOH and amine for active site construction.

1.0 g EA coated silica (containing 3.35 mmol Al) from Example 3—ASPECT FOUR and 3.0 g toluene were charged to a 20 mL vial and the mixture was mixed well. 0.20 g 2,6-Me₂PhOH (1.6 mmol) and 1 g toluene were charged to a 4 mL vial. The phenol solution was then slowly added to the EAO coated silica slurry, followed by the addition of 0.06 g PhNMe₂ (0.49 mmol). After vigorous shaking on a shaker for 60 min, the mixture was filtered through a coarse frit, washed two times with 5 g isohexane, and dried under vacuum for 10 min. The solid was then transferred back to the 20 mL vial. 4.0 g toluene and 20 mg M6 solid (48 μmol) were added to the solid, followed by vigorous shaking on a shaker for 60 min. The mixture was then filtered through a coarse frit, washed two times with 5 g isohexane, and dried under vacuum for 45 min, giving a 1.23 g yield. Al: 6.95%; Zr: 0.27% (Table 7, Entry 6).

### Example 12

### Aspect Four—2,6-Me₂PhOH/EAO-m/Silica I/M6

This preparation used only 2,6-Me₂PhOH for active site construction.

In the glovebox, 1.0 g EAO-m coated silica (containing 4.24 mmol Al) from Example 4—ASPECT FOUR and 3.0 g toluene were charged to a 20 mL vial and the mixture was mixed well. 0.20 g 2,6-Me₂PhOH (1.64 mmol) and 1 g toluene were charged to a 4 mL vial. The phenolic alcohol solution was then slowly added to the EAO-m coated silica I slurry. The slurry was then placed on a shaker to shake for 60 min. The mixture was then filtered through a coarse frit, washed two times with 3 g toluene, and dried under vacuum for 30 seconds. The wet solid was transferred back to the 20 mL vial. 3.0 g toluene and 17 mg M6 solid (41 μmol) were added to the wet solid, followed by vigorous shaking on a shaker for 60 min. The mixture was then filtered through a coarse kit, washed two times with 3 g toluene, and dried under vacuum for 30 min to yield 1.30 g product. Al: 9.00%; Zr: 0.166% (Table 7, Entry 7).

### Example 13

### Aspect Four—C₆F₅OH/EAO-m/Silica III/M6

This preparation used only C₆F₅OH for active site construction.

In the glovebox, 3.0 g EAO-m coated silica III (containing 13.8 mmol Al) from Example 5—ASPECT FOUR and 8.7 g toluene were charged to a 20 mL vial and the mixture was mixed well. 0.56 g C₆F₅OH (3.04 mmol) and 1.1 g toluene were charged to a 4 mL vial. The phenolic alcohol solution was then slowly added to the EAO-m coated silica III slurry. The slurry was then placed on a shaker to shake for 25 min. The mixture was then filtered through a coarse frit, washed two times with 5 mL toluene, and dried under vacuum for 10 min. The wet solid was transferred back to the 20 mL vial. 8.0 g toluene and 51 mg M6 solid (123 μmol) were added to the wet solid, followed by vigorous shaking on a shaker for 60 min. The mixture was then filtered through a coarse fit washed two times with 10 mL toluene and 15 mL isohexane, and dried under vacuum for 45 min to yield 3.32 g product. Al: 10.235%; Zr: 0.27% (Table 7, Entry 8).

### Example 14

### Aspect Four—C₆F₅OH/EAO-m/Silica I/Amine/M6

This preparation used only C₆F₅OH and amine for active site construction.

In the glovebox, 1.0 g EAO-m coated silica I (containing 4.24 mmol Al) from Example 4—ASPECT FOUR and 3.0 g toluene were charged to a 20 mL vial and the mixture was mixed well. 0.18 g C₆F₅OH (0.98 mmol) and 0.9 g toluene were charged to a 4 mL vial. The phenolic alcohol solution was then slowly added to the EAO-m coated silica I slurry. The slurry was then placed on a shaker to shake for 90 min. The shaker was stopped to add 0.064 g PhNMe₂ (0.53 mmol) and then the mixture was shaken for 30 min. The mixture was then filtered through a coarse frit washed two times with 3 g toluene, and dried under vacuum for 30 seconds. The wet solid was transferred back to the 20 mL vial. 3.0 g toluene and 20 mg M6 solid (48 μmol) were added to the wet solid, followed by vigorous shaking on a shaker for 60 min. The mixture was then filtered through a coarse frit, washed three times with 3 g toluene and 3 g isohexane, and dried under vacuum for 60 min to yield 1.11 g product. Al: 10.1%; Zr: 0.40% (Table 7, Entry 9).

### Example 15

### Aspect Four—EAO-m/Silica I/M6

This preparation used no phenolic compound.

In the glovebox, 1.2 g EAO-m coated silica (containing 5.09 mmol Al) from Example 4—ASPECT FOUR and 3.0 g toluene were charged to a 20 mL vial and the mixture was mixed well. 15 mg M6 solid (36 μmol) were then added, followed by vigorous shaking on a shaker for 60 min. The mixture was then filtered through a coarse frit, washed three times with 4 g toluene, and dried under vacuum overnight to yield 1.2 g product (Table 7, Entry 10).

### Example 16

### Aspect Four—Polymerization Test

The dried 4 L reactor was heated to 80° C. under low-pressure nitrogen flow. The reactor was pressured with isobutene and vented three times to remove nitrogen. After 1000 ml of isobutene were charged into the reactor, the reactor agitator was set at 800 rpm. After the stabilization of temperature, ethylene was charged into the reactor up to 320 psi for all supported catalysts except supported M7 and 450 psi for supported M7. Then 40 ml of dried 1-hexene were charged, followed by 500 ml of isobutene. Next, 2 ml of 10% TIBA was added as scavenger agent. Typically 50-100 mg of solid catalyst were slurred in 2 ml of hexane in glovebox and then injected into the reactor, followed by another 500 ml of isobutene. The reaction pressure was maintained at 320 psi or 450 psi (M7) and reaction was conducted for 60 minutes at 80° C. The reaction was stopped and isobutene was vented. The polymer was dried and weighed. The polymerization activity of each catalyst was calculated and listed in Table 7.

While the present invention has been described in terms of one or more preferred embodiments, it is to be understood that other modifications may be made without departing from the scope of the invention, which is set forth in the claims below.

1. A composition derived from at least:
a) carrier;
b) organoaluminoxy compound;
c) component having at least one electron withdrawing group and at least one active proton; and
d) ionic compound having at least one active proton.

2. The composition of claim 1, wherein the carrier comprises inorganic oxide, preferably an inorganic oxide that has a micro pore volume of not less than about 0.3 ml/g and an average particle diameter of about 10 micrometers to about 500 micrometers.

3. (canceled)

4. The composition of claim 2 wherein the inorganic oxide comprises silica, alumina, silica-alumina, magnesia, titania, zirconia, or clays, preferably silica.

5. (canceled)

6. The composition of claim 1 wherein the organoaluminoxy compound comprises aluminoxane, preferably alkylaluminoxane, more preferably methylaluminoxane, ethylaluminoxane, n-propylaluminoxane, iso-propylaluminoxane, n-butylaluminoxane, iso-butylaluminoxane, sec-butylaluminoxane, n-pentylaluminoxane, n-hexylaluminoxane, n-heptylaluminoxane, or n-octylaluminoxane, even more preferably ethylaluminoxane.

7-9. (canceled)

10. The composition of claim 1 wherein the component having at least one electron withdrawing group and at least one active proton comprises pentafluorophenol, 2,3,5,6-tetrafluorophenol, 2,4,6-trifluorophenol, 2,3-difluorophenol, 2,4-difluorophenol, 2,5-difluorophenol, 2,6-difluorophenol, 3,4-difluorophenol, 3,5-difluorophenol, 2-fluorophenol, 3-fluorophenol, 4-fluorophenol, 2-trifluoromethylphenol, 3-trifluoromethylphenol, 4-trifluoromethylphenol, pentafluorobenzyl alcohol, pentafluorothiophenol, 2,2,2-trifluoroethyl alcohol, 1H,1H-pentafluoro-propanol, 1,1,1,3,3,3-hexafluoro-2-propyl alcohol, pentachlorophenol, pentabromophenol, 2-chloro-4-fluorophenol, 2-bromo-4-fluorophenol, 2-bromo-4,5-difluorophenol, tetrafluorocatechol, or tetrafluorohydroquinone, preferably pentafluorophenol.

11. (canceled)

12. The composition of claim 1, wherein the ionic compound having at least one active proton is derived from at least Lewis base and a portion of the component having at least one electron withdrawing group and at least one active proton, wherein the Lewis base comprises at least one NR²₃, wherein each R² is independently hydrogen or a hydrocarbyl group having up to about 20 carbon atoms, preferably the Lewis base comprises NMe₂Ph, NMe₂(CH₂Ph), NEt₂Ph, NEt₂(CH₂Ph), NMe(CₙH₂ₙ₊₁)(CₘH₂ₘ₊₁), NMe₂(CₙH₂ₙ₊₁), NEt(CₙH₂ₙ₊₁)(CₘH₂ₘ₊₁), or NEt₂(CₙH₂ₙ₊₁) wherein n and m are independently an integer from 3 to 20.

13-14. (canceled)

15. The composition of claim 1, wherein the composition is adapted to activate an alkylated transition metal component by protonation.

16. A catalyst for olefin polymerization, wherein the catalyst comprises the composition of claim 1 and alkylated transition metal component.

17. A method of preparing a composition comprising combining at least:
a) carrier;
b) organoaluminoxy compound;
c) component having at least one electron withdrawing group and at least one active proton; and
d) ionic compound having at least one active proton.

18. The method of claim 17 wherein the carrier comprises inorganic oxide.

19. The method of claim 17 wherein the carrier, the organoaluminoxy compound, the component having at least one electron withdrawing group and at least one active proton, and the ionic compound having at least one active proton are combined in amounts sufficient and under conditions sufficient such that the composition is adapted to activate alkylated transition metal component by protonation.

20. The method of claim 17 wherein the carrier is combined with the organoaluminoxy compound to form first product, at least a portion of the first product is combined with the component having at least one electron withdrawing group and at least one active proton to form second product, and at least a portion of the second product is combined with the ionic compound having at least one active proton.

21. A method of preparing a catalyst for olefin polymerization, comprising combining alkylated transition metal component with composition derived from at least carrier; organoaluminoxy compound; component having at least one electron withdrawing group and at least one active proton; and ionic compound having at least one active proton.

22. A method of polymerizing monomer comprising combining catalyst of claim 16 and monomer.

23. A method of polymerizing monomer comprising combining composition of claim 1, alkylated transition metal component, and monomer.

24. A composition derived from at least:
a) carrier;
b) organoaluminoxy compound;
c) component having at least one electron donating group and at least one active proton, and/or component having at least one electron withdrawing group and at least one active proton, and optionally, and
d) Lewis base.

25. (canceled)

26. A method of preparing a composition comprising combining at least:
a) carrier;
b) organoaluminoxy compound;
c) component having at least one electron donating group and at least one active proton, and/or component having at least one electron withdrawing group and at least one active proton, and, optionally, and
d) Lewis base.

27. The method according to claim 26 wherein said method further comprises combining alkylated transition metal component with composition derived from a), b), c), and optionally d).

28-37. (canceled)
